(19) United States
(12) Patent Application Publication
(10) Pub. No.: US 2019/0210881 A1
(43) Pub. Date: Jul. 11, 2019

(54) ELECTROHYDRODYNAMIC STIMULATED ASSEMBLY OF HIERARCHICALLY POROUS, FUNCTIONAL NANOSTRUCTURES FROM 2D LAYERED SOFT MATERIALS

(71) Applicant: The Regents of the University of California, Oakland, CA (US)

(72) Inventors: Vincent Chunchih Tung, Merced, CA (US); Michelle Khine, Merced, CA (US)

(73) Assignee: The Regents of the University of California, Oakland, CA (US)

(21) Appl. No.: 15/770,103

(22) PCT Filed: Oct. 24, 2016
(86) PCT No.: PCT/US2016/058517

§ 371 Date: Apr. 20, 2018

Related U.S. Application Data
(60) Provisional application No. 62/245,802, filed on Oct. 23, 2015.
(60) Provisional application No. 62/245,806, filed on Oct. 23, 2015.

(51) Int. Cl. C01B 32/194; B01D 71/02; B01D 67/00; C02F 1/44; B05D 1/04; B05B 5/053; B05D 3/02

(52) U.S. Cl. CPC C01B 32/194; B01D 71/021; B01D 67/0069; B82Y 30/00; B05D 1/04; B05B 5/053; B05D 3/0254; C02F 1/44

(57) ABSTRACT

A method for producing a nanostructure or an article having at least a nanostructured portion includes obtaining a colloidal suspension of sheets of material for forming nanoparticles, the sheets being less than four atomic layers thick and the colloidal suspension having a preselected concentration of the sheets of material suspended therein; supplying the colloidal suspension to an electro-hydrodynamic system, the electro-hydrodynamic system including a spray nozzle, a ground electrode spaced apart from the spray nozzle, and a high voltage DC power supply electrically connected to the spray nozzle and the ground electrode, the high voltage DC Power supply being suitable for supplying at least a 0.05 kV/cm electric field between the spray nozzle and the ground electrode; providing a substrate arranged between the spray nozzle and the ground electrode such that droplets from the spray nozzle are directed to the substrate to deposit nanostructures thereon; and applying a DC voltage using the high voltage DC power supply between the spray nozzle and the ground electrode such that charged droplets from the spray nozzle are repelled from the spray nozzle and attracted towards the substrate. The DC voltage is selected such that the droplets have sizes sufficiently small to result in substantially isolated sheets within each droplet.

This application is a U.S. National Stage Application under 35 U.S.C. § 371 of PCT/US2016/058517, filed Oct. 24, 2016, the entire content of which is hereby incorporated by reference, and claims the benefit of U.S. Provisional Application No. 62/245,802 filed Oct. 23, 2015, and U.S. Provisional Application No. 62/245,806 filed Oct. 23, 2015, the entire contents of which are hereby incorporated by reference.

### BACKGROUND

### 1. Technical Field

The currently claimed embodiments of the current invention relate to electro-hydrodynamic stimulated assembly of hierarchically porous, functional nanostructures from 2D layered soft materials.

### 2. Discussion of Related Art

In aerosol assembly, solvent evaporation drives the anisotropic crumpling process of graphene contained in aerosol droplets. As solvent is rapidly lost, sheets begin to aggregate due to strong intermolecular forces, ultimately clumping into crumpled balls. Although the resultant crumpled balls proved to be resistant to compressive forces and can be packed into high-density configurations, the overall performance is still far from ideal as a result of graphite-like walls. This also in turn generates monolithic materials with less desirable properties. Thus it is highly desirable to develop strategies that allow one to effectively harness the extraordinary material properties of single-to-few layered crumpled graphene nanostructures (CGNs), especially when assembled in a monolithic fashion. Indeed, the ability to reduce the number of layers of 3D structures upon assembling into macroscopic composites can not only be crucial for building new types of capacitors, batteries, sensors, and even actuators, but also may be paramount for future development of new generations of scaffolds with catalytically active, energetically favorable, and chemically defined interfaces.

There thus remains a need for improved methods for producing nanostructures and for improved nanostructures obtained by improved methods of production.

### SUMMARY

A method for producing a nanostructure or an article having at least a nanostructured portion according to some embodiments of the current invention includes obtaining a colloidal suspension of sheets of material for forming nanoparticles, the sheets being less than four atomic layers thick and the colloidal suspension having a preselected concentration of the sheets of material suspended therein; supplying the colloidal suspension to an electro-hydrodynamic system, the electro-hydrodynamic system including a spray nozzle, a ground electrode spaced apart from the spray nozzle, and a high voltage DC power supply electrically connected to the spray nozzle and the ground electrode, the high voltage DC Power supply being suitable for supplying at least a 0.05 kV/cm electric field between the spray nozzle and the ground electrode; providing a substrate arranged between the spray nozzle and the ground electrode such that droplets from the spray nozzle are directed to the substrate to deposit nanostructures thereon; and applying a DC voltage using the high voltage DC power supply between the spray nozzle and the ground electrode such that charged droplets from the spray nozzle are repelled from the spray nozzle and attracted towards the substrate. The DC voltage is selected such that the droplets have sizes sufficiently small to result in substantially isolated sheets within each droplet.

A nanostructured article or nanostructured article portion according to some embodiments of the current invention is produced using a method according to an embodiment of the current invention.

A nanostructure or an article having at least a nanostructured portion according to an embodiment of the current invention includes a plurality of crumpled nanoparticles formed into a self-supporting structure. The crumpled nanoparticles have walls having thicknesses of less than four atomic layers.

### BRIEF DESCRIPTION OF THE DRAWINGS

Further objectives and advantages will become apparent from a consideration of the description, drawings, and examples.

FIGS. 1A-1F illustrate Electrohydrodynamic synthesis of CGNs. (a) Schematic drawing illustrates the setup of EHD process of synthesizing CGNs. Temperature gradient is measured by a noncontact IR laser temperature gun. (b) Self-dispersing droplets can be viewed as charged, nano-colloidal systems that undergo stages of (i) electrostatic repulsion, (ii) fission and, (iii) capillarity-induced crumpling, ultimately leading to the formation of CGNs. HRSEM images of samples taken along the trajectory of deposition demonstrate a series of transition from (c) flat, and (d) crumpled rGOs to (e) crumpled nanostructures. (0 False colored, SEM and HRTEM (inset) images reveal the thin and semi-transparent wall of a single CGN. Scale bars are 1 μm for (c), (d), and (e), and 50 nm for (0, respectively.

FIGS. 2A-2C show an example of the EHD process. (a) Schematic illustration of the EHD process comprises of a programmable translational stage, micro-hotplate, a high-speed camera, a high voltage generator, and a syringe pump. (b) Representative snapshot taken from high-speed camera provides a close-up view of the formation of a Taylor cone under a high electric field. (c) False-colored, cross-sectional SEM image reveals the compressive resistant nature of CGNs. Scale bar is 100 nm.

FIGS. 3A-3C show SEM and AFM images along with a 3D profile showing the spatial distribution of individual rGO sheets through EHD deposition at room temperature and electric field of 0.575 kV/cm and FIGS. 3D-3F show densely tiled rGO sheets start developing wrinkles and undulations when concentration exceeds 0.5 mg/ml. In specific, height profile presented in 3D further reveals the relatively rough terrain as a result of lateral compression upon evaporation. In both samples, height profile taken along white line highlights the step height of 1 nm, indicating single layer conformation. Scale bar is 500 nm.

FIGS. 4A-4F provide, in accordance with Table 1, SEM images showing crumpling behavior of rGO under various conditions. Without applying an external electric field, (a) to (c), rGO sheets are prone to aggregation and start developing wrinkles upon annealing. Alternatively, under a high electric filed, rGO sheets remains single layer conformation when depositing at low temperature. When annealing temperature is gradually increased, planar rGOs gradually transform into (e) folded and ultimately (f) fully crumpled morphology. Computer generated models taken from the snap shots of MD simulation show such a morphological evolution at different stages.

FIGS. 5A-5C show surface activity of GO and rGO in aqueous dispersions at pH 11. (a) Because of the high surface energy and charges, GO sheets tend to submerge within the droplets. Therefore, GO sheets leave the typical “coffee ring stain” type of drying patterns, commonly seen for aqueous colloidal dispersions. (b) In contrast, rGO sheets first develop coffee ring like drying marks as a result of high negatively charged surface at pH 11. Upon evaporation, the pH value of rGO colloidal dispersions gradually returns to a more acidic state where surface charges drastically reduce. This leads to the irreversible and random precipitation of rGO aggregations. Scale bars are 1 μm, respectively. (c) Zeta potential as a function of wide pH ranges juxtaposes the surface activity of GO and rGO sheets in colloidal dispersions.

FIG. 6A MD simulation reveals the change of potential energy during the crumpling process of rGO. FIG. 6B shows snapshots taken from MD simulation illustrate the stages of crumpling process of rGO. FIG. 6C is a schematic diagram of crumpling scenarios as a function of aspect ratios establishes a predictive shape-engineering principle for CGNs.

FIGS. 7A-7H show conformational evolution of CGNs through geometrical engineering of rGO sheets. (Top) SEM images of rGO sheets with: (a) polyhedron; (b) square; (c) rectangle; and (d) a mixture of anisotropic shapes and polydispersed sizes, respectively. Scale bars are 2 μm. (Bottom) Corresponding SEM images of CGNs with various conformations, including (e) spheres, (0 sacks, (g) tubes and (h) a mixture of all generated through EHD process. Scale bars are 200 nm for (e, f, and g) and 5 μm for (h).

FIGS. 8A-8C show surface properties of CGNs. (a) Zeta potential of rGO colloidal dispersions as a function of pH measured at a concentration of ˜0.1 mg/ml shows drastically distinct assembling behaviors. (b) Corresponding SEM images of the resulting CGNs show a myriad of morphology under different pH. Scale bars are 1 (c) Computer generated models indicate the protonation and de-protonation of carboxylic groups resided at the edges of rGOs. Diameters of CGNs can be thus tuned through the change of pH values. Under high pH, electrostatic force renders the high negatively charged sheets repel from each other, thus reducing the overall diameters.

FIGS. 9A-9D show (a) Macroscopic salting effect induces irreversible agglomerations of rGO aqueous dispersions. (b) Schematic illustration depicts the setup of coaxial EHD assembly to emulate the macroscopic salting effect at nanoscale. (c) SEM image shows the resulting crumpled balls made of multilayered rGOs along with a close up view (d). Adding electrolytes adversely affects the electrostatic stabilization, leading to irreversible agglomeration with highly wrinkled morphology.

FIGS. 10A-10C show (a) Optical and (b), (c) SEM images of arrays of rectangular patterns of CGN monoliths made by employing mask-assisted EHD process, resulting in 40 μm×40 μm rectangular patterns separated by 50 μm-wide lines.

FIGS. 11A-11F show (a) Optical, and (b), (c) SEM images show arrays of FET transistor electrodes used for conductivity measurements. Densely populated CGNs are produced by iterative EHD process onto the Si/SiO₂ substrates, followed by thermal deposition of gold electrodes with underlying chromium adhesion layer. Spacing between two electrodes is 200 μm. Output curves juxtapose the conductivity measured on (d) GO specimens and (e) CGN monoliths. (f) A comparison of electrical conductivity values for GO, rGO, and CGNs, respectively. CGN monoliths display a comparable conductivity with respect to rGOs while exhibiting a drastic enhancement of 6 orders of magnitude when compared to that of GO.

FIGS. 12A and 12B show (a) BET N₂ adsorption/desorption isotherms of CGN monoliths, with arrows indicating various condensations along with (b) corresponding pore-size distributions based on BJH calculation.

FIG. 13A-13F show (a) Tilted (45°), (b) cross-sectional view of SEM, and (c) TEM images provide various perspectives of the CGN monoliths. Scales are 10 μm, 500 nm, and 20 nm, respectively. In specific, TEM image of CGN monoliths reveals the extremely thin and largely wrinkled walls joined by folded edges. (d) Representative galvanostatic charge/discharge curves of symmetrical ultracapacitor devices measured at a constant current of 1 A/g and mass loading of 2 mg per electrodes. Specific capacitance of CGN networks as a function of both (e) mass loading and (0 current density, respectively.

FIGS. 14A-14F show (a) The CGN-based capacitor shows good cyclic stability and retains >95% of its initial response after 6,000 cycles. The capacitance gradually degrades afterwards as a result of detachment of CGNs at the top layers as shown in the HRSEM (b). Cross sectional SEM image of (c) stacked rGO sheets shows the preferential packing of rGO sheets normal to the direction of electron transport while (d) 3D crumpled monoliths form interconnected pathways. Scale bars are 10 μm. (e) Nyquist plot and (f) volumetric capacitance of CGN monoliths of different aerial mass loading. The inset of (c) shows the zoom-in view of the interactions with the Z′ axis, indicating the ohmic resistance of the devices.

FIGS. 15A-15F show 3D CGN/TiO₂ based photoanodes. (a) SEM image of CGNs deposited on carbon fiber electrodes at low temperature. (b) HRSEM image provides a close-up view of the discrete, and semi-transparent CGNs spatially distributed on the CFE surface. (c) Schematic illustration depicts the experimental setup of PEC measurements under AM 1.5 G irradiation. (d) Output current-voltage characteristics and (e) time-dependent light pulse response collectively demonstrates the much improved carrier transport at interfaces when incorporating 3D CGNs. (0 Cross-sectional HRSEM shows that the largely porous and vertically extended CGN constitutes the electron transport pathway within particulate TiO₂ active layers. Scale bar is 50 nm.

FIGS. 16A-16C show the spatial distribution of CGN modification layers can be systematically tuned through the duration of deposition time.

FIGS. 17A-17E show (a) (top) Proposed energetics that is experimentally determined by UPS suggests the efficient transport of dissociated electron-hole pairs. Photograph of the 3D CGN/TiO₂ photoanodes deposited on CFEs. (bottom) SEM image shows the uniform and conformal coating of TiO₂ nanoparticles. Scale car is 5 μm. (b) Comparisons of photogenerated charge carrier collection at 3D CGN/TiO₂ textured (left) and planar (right) photoanodes. (c) 3D CGN scaffolds establish well-extended charge transport pathways where electrons can be readily shuttled to the collecting substrates. On the other hand, electrons propagated within planar electrodes (d) need to overcome energetically unfavorable grain boundaries made of numerous particulate TiO₂. Scale bars are 200 nm. (e) Cross-sectional SEM image in tandem with the corresponding EDX mapping of relevant elements, including C in red and Ti in blue, reveal the vertically extended graphitic transport networks within particulate TiO₂ absorbers. Scale bards are 200 nm.

FIGS. 18A-18H show (a) HRSEM image shows the crumpled clay nanosheets. Scale bar is 200 nm. Large area of CMoS₂ can be deposited on the flexible CFEs as indicated in top-down (b) and titled (c) view of SEM images. Scale bars are 2 μm and 500 nm, respectively. Corresponding EDX mapping of relevant elements, including (d) carbon in red, (e) molybdenum in green and (f) sulfur in blue, conclusively confirm the uniform distribution of CMoS₂ all over the CFE. Scale bars are 2 μm. In addition, EDX spectra provide the pertinent element information of CGNs infiltrated with guest molecules, including (g) TiO₂, and (h) silicon nanoparticles.

FIGS. 19A-19F show HRSEM images showing that the EHD process enables the dimensional transition of (a) planar MoS₂ to (b) CMoS₂. In addition, (c) TiO₂, and (e) Si, can be co-assembled or entrapped within the open void of CGNs to afford hybrid nanocomposites of (d) CGN/TiO₂, and (0 CGN/Si, respectively.

FIG. 20 provides a schematic illustration that depicts the interfacial assembly of hybrid CGN composites. The incorporation of coaxial orifices enables the direct integration of functional nanoparticles with dissimilar solubility characteristics.

FIG. 21 shows a schematic drawing that illustrates a setup of EHD process of synthesizing CGNs. As shown on the bottom right of FIG. 7, a droplet is shown formed on a hydrophobic surface, where the droplet has a contact angle of 150°. As a comparative example, a result obtained from a droplet landing on a hydrophilic surface is shown on the top right of FIG. 21. SEM images next to the two examples show that crumpled rGO is formed from the droplet that landed on a hydrophobic surface, whereas the hydrophilic surface results in wrinkled rGO.

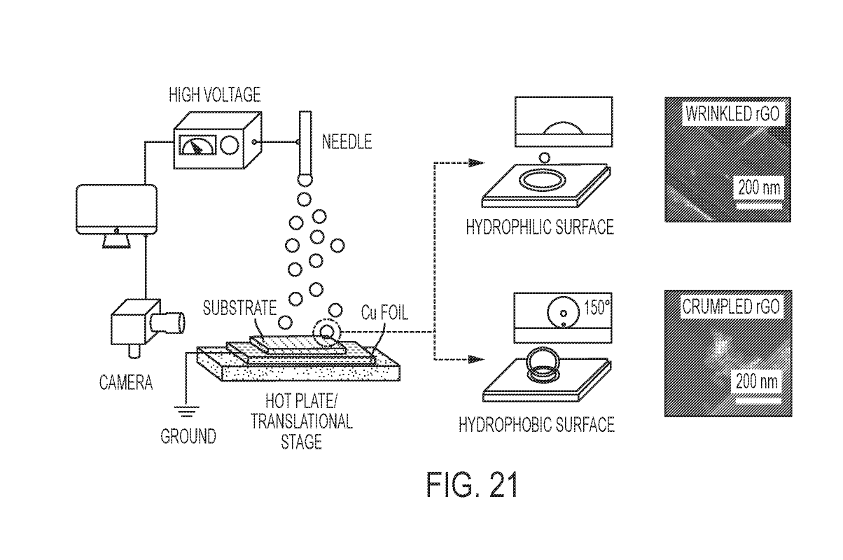

FIGS. 22A-22F show examples for MoS₂.

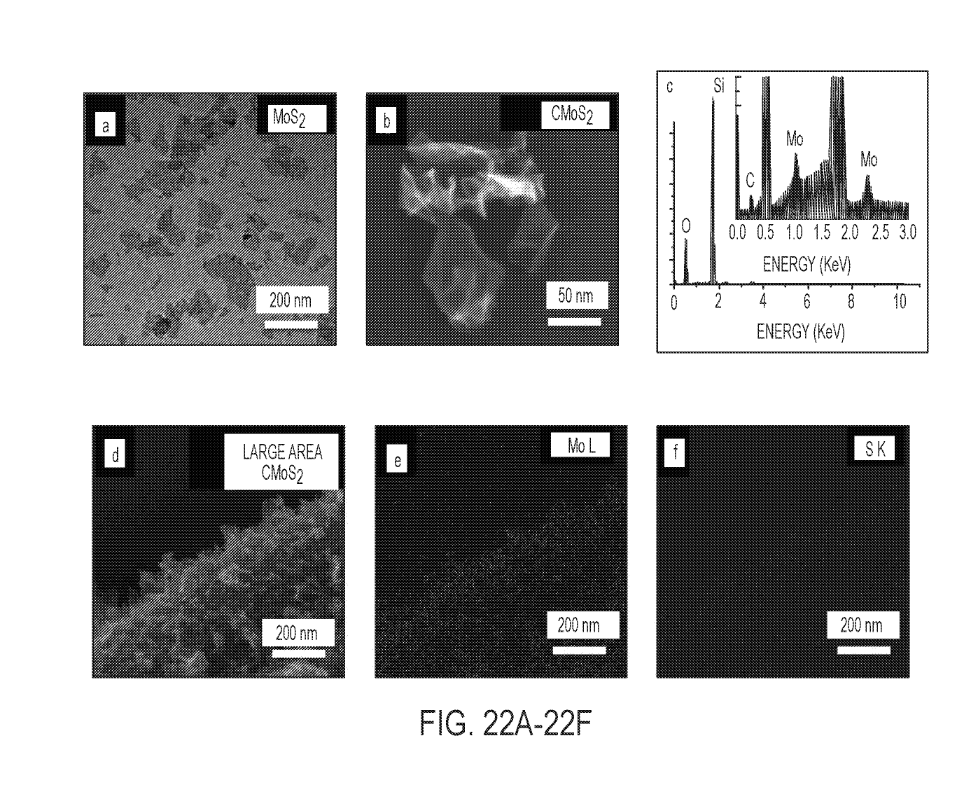

FIG. 23 shows an SEM image of crumpled nanoclay formed using the EHD process according to an embodiment of the invention, in which the collecting substrate had a hydrophobic surface.

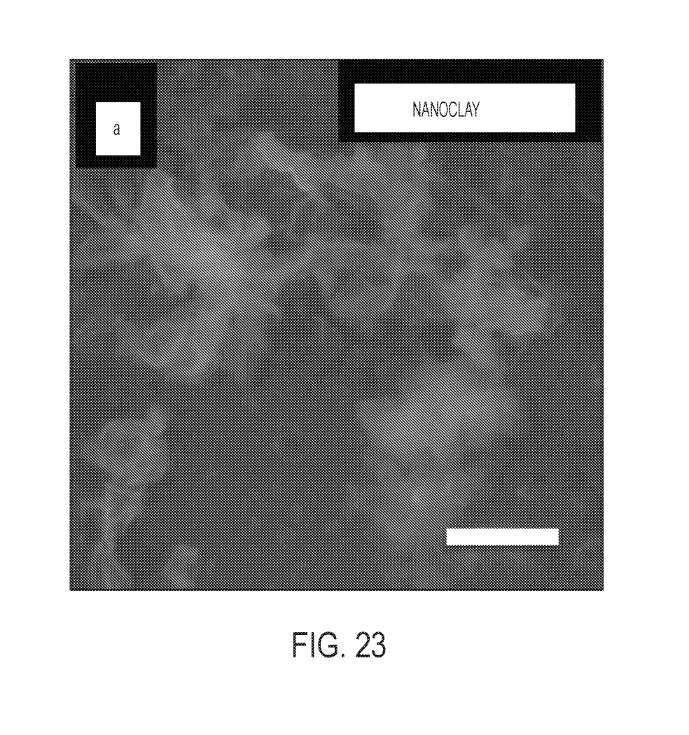

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “nanoparticle” is intended to include any particles that have a longest dimension that is submicron in size down to about 1 nm, i.e., 1 nm to 999 nm.

The term “crumpled nanoparticles” is intended include the resultant nanoparticles following a change in morphology of substantially 2D nanoparticles. This change in morphology can result from a curving, bending, folding, wrinkling, creasing, crumpling, or compressing of the substantially 2D nanoparticles. The crumpled nanoparticles thus result in nanoparticles that have structure extending out of the original plane of the substantially planar precursor 2D nanostructure.

The term “single-to-few layered” structure is intended to refer to exfoliated molecular structures of single atomic layer thickness in some embodiments, up to two atomic layers in some embodiments, or up to three atomic layers in some embodiments. Such structures will also be referred to as 2D layered soft sheets. Three layers of graphene are the upper limit of CGNs. Beyond three layers, the material property of graphene will become graphite-like.

The term “substrate” is intended to have a broad meaning that can include any surface on which it is intended to form nanoparticles. The surface can serve for producing individual nanostructures, a self-supporting final structure consisting essentially of the nanostructures (e.g., but not limited to, a filter, a catalyst, an element of a battery, a supercapacitor, an ultra-capacitor and/or a fuel cell), or could be the portion of a device, such as, but not limited to an electronic device (e.g., but not limited to, a capacitor, a diode, a transistor, and/or a photovoltaic cell). The substrate can be a hydrophobic surface in at least portions and/or hydrophilic in portions. The substrate can also have a structure, such as, but not limited to a nanostructure in at least portions thereof.

For decades, it has been known that the electro-hydrodynamic (EHD) process can atomize liquid media for high throughput production of thin film specimens. A high voltage applied between the nozzle and a conductive support plate creates an electro-hydrodynamic phenomenon that drives the flow of colloidal dispersions out of the nozzle. An ultra-high D.C. voltage (kV) is applied between the nozzle tip and the metal plate using a computer controlled power supply to generate an electric field that causes charged species within the liquid medium to accumulate near the surface of the pendent meniscus. The escalating columbic repulsions between charged species induce a tangential stress on the liquid surface, thereby deforming the meniscus into a conical shape, known as a Taylor cone. At a sufficiently high electric field, the electrostatic stress overcomes the capillary tension at the apex of the liquid cone, giving rise to fine, charged droplets. The electric field can be greater than 0.05 kV/cm in some embodiments. In some embodiments, the electric field can be greater than 0.1 kV/cm. In some embodiments, the electric field can be, for example, 0.575 kV/cm. However, the electric field is not limited to these values. This unique feature can be significantly useful in the case of graphene and its derivatives in colloidal dispersions since the highly charged microenvironment first and foremost electrostatically stabilizes 2D layered soft sheets owing to the much-enhanced electrostatic repulsion spanning from the needle to collecting substrates. Next, the largest droplet just after separation from liquid jets has a charge density that exceeds the Rayleigh limit. At this point, large droplets will undergo a fission process to disseminate into highly charged, self-dispersing droplets with nearly monodispersed diameter distribution in sub-micron to nanometer ranges. In contrast to the aerosol process where shrinkage of droplets induces the folding of 2D layered soft sheets, the fission process readily reduces the loading of 2D layered soft sheets in each droplet. In this light, individual fine droplets will only contain a limited number of sheets, further reducing the possibility of irreversible aggregation.

Results Obtained Using High Resolution Scanning Electron Microscopy (HRSEM) Image of Spatially Separated 2D Layered Soft Sheets Deposited Via EHD Process at Room Temperature

The resultant 2D layered soft sheets appear to separate from each other without agglomerations, underscoring the importance of the electrostatically stabilizing microenvironment. SEM, atomic force microscopy (AFM), and a 3D profile scanned across a myriad of 2D layered soft sheets further reveals a step height of ˜1 nm, confirming the single layer identity. The ability to create single layer 2D layered soft sheets not only supports the hypothesis of electrostatically charged nanoreactors but also provides a means to obtain single layer specimens for device fabrication through a room temperature EHD process. Finally, upon annealing, metastable and adaptable droplets can act as individual nanoreactors to facilitate capillarity induced compressive forces introducing networks of ridges, ripples, folds and vertices to initiate the deformation process on the basal plane.

As a result of the EHD process, hierarchically porous, functional 3D nanostructures can be formed. Embodiments of the invention can use a variety of layered or substantially 2D soft materials, including graphene, clay, semiconductors, metals, and metal chalcogenides, dichacolgenides and transitional metal dichalcogenides (TMDs). For example, molybdenum disulfide can be used according to an embodiment. Embodiments of the invention are not limited to the materials listed, and may include any 2D materials. The resulting 3D or crumpled nanostructures can have walls that are single- to a few-layers thick. These crumpled nanostructures, and microscopic monoliths assembled from them, provide many useful material properties, including properties relevant to energy harvesting and storage. These material properties include high surface area, good electrical conductance, preserved capacity, and excellent photochemical properties, which can be effectively harnessed for macroscopic applications.

According to some embodiments, multicomponent crumpled structures and the encapsulation of guest species with dissimilar solubility into 3D nanostructures are possible. Thus, it is possible to form hybrid nano-building blocks that have the advantage of combining the complementary strength from both chemical worlds.

The combination of electrostatic and capillary cues stemmed from EHD processes collectively decouples exceptional properties from the layer dependent electronic structures of 2D soft layered derivatives. This embodies an important step to end the chasm between academic prototype and industrial implementation of graphene-based composites where the difficulties lie in the design of a hierarchically functional architecture that allows for extraordinary material properties of individual sheets to be effectively harnessed.

According to some embodiments of the current invention, the crumpled nanostructures and microscopic monoliths assembled from the crumpled nanostructures can be adapted for use in a variety of applications, including desalination, water remediation, chemistry, fluid dynamics, materials science, engineering, environmental remediation, health and sanitation, catalytic elements, actuators, medical devices, composite materials, biomedical sciences, agriculture, energy and infrastructure applications, and space applications, for example. An embodiment of the invention is able to provide a scalable platform for mass production of single to few layered crumpled graphene nanostructures for these applications.

According to some embodiments of the invention, the collecting substrate can be textured and/or chemically heterogeneous. As used herein, “chemically heterogeneous” refers to dissimilar chemical properties stemming from spatially distributed chemical functional groups. In some embodiments, the collection substrate is hydrophobic or super-hydrophobic, and/or can be nano-textured. These features, alone or in combination, can affect the hydrodynamics of droplets containing 2D materials. Whether or not the 2D materials undergo dimensional transition, or the extent to which dimensional transition occurs, upon solvent evaporation can be impacted by the direction of capillary forces. For example, when the surface of the substrate is hydrophobic, droplets will tend to remain in spheres or more spherical shapes, as opposed to spreading out on the surface. Such spherical shapes can be considered 3D platforms that exert omnidirectional capillary forces upon drying, thus forming 3D crumpled structures. On the other hand, water droplets on hydrophilic surfaces will tend to spread out on the surface, and will therefore generate capillary forces mostly in the lateral directions, or parallel to the plane of the surface. As a result, 2D sheets collected on hydrophilic surfaces are more likely to form sheets that are only wrinkled or creased, as opposed to being crumpled.

The use of a hydrophobic and/or nano-textured surface can enhance low-temperature processing capabilities of embodiments of the invention. Low-temperature processing can enable the use of a wider range of materials and applications, including polymers and flexible substrates.

The ability to reduce the number of layers of CGNs upon assembling into macroscopic composites will not only be crucial for building new types of capacitors, batteries, sensors, and even actuators, but also will be paramount for future development of a new generation of scaffolds with catalytically active, energetically favorable, and chemically defined interfaces. The discovery is extremely significant and is a very high-priority development opportunity representing the most effective solution for bulk implementation of graphene based materials as well as other 2D soft sheets made of either metallic, semi-metallic or insulating elements.

The following examples describe some embodiments in more detail. The broad concepts of the current invention are not intended to be limited to the particular examples. Further, concepts from each example are not limited to that example, but may be combined with other embodiments of the system.

### Examples

The structures and methods according to various embodiments can facilitate dimensional transition of 2D layered soft materials into 3D porous and hierarchically functional nanostructures. Taking graphene as an example, graphene colloidal dispersions (0.5 mg/ml, 40 ml) made from a modified Hummers' approach were mixed with 0.1 ml hydrazine (35 wt % in water) and 0.56 ml ammonia (28 wt % in water) to adjust pH to 11 in a flask and stirred in a water bath at 95° C. for 1 hour. Flat graphene papers were prepared by vacuum filtrating of 8 ml as obtained graphene colloidal dispersion through an isopore membrane filter paper (100 nm pore size). To synthesize 3D nanostructures, graphene dispersions (50 ug/mL) were fed through a customized EHD setup. Note that pH of graphene dispersions are preferably maintained at 11 to obtain desired electrostatic force for isolating individual graphene sheets. In a typical experiment, solutions are fed to the spray head (gauge 23 TW needle) by a syringe pump. Electric fields are generated through a high power supply (ES 40P-20 W/DAM, Gamma high voltage research) with a distance of 10 cm measured from the tip of spinneret to collecting substrates. Computerized multi-pass deposition is achieved through the integration of x-y translational stage (Newport, moving speed 2 mm/sec) and micro-heating plate. A table of detailed operating parameters, including concentration, solution feed rate, and annealing temperature, to afford 3D graphene nanostructures can be found in Table 1. In an analogous fashion, other 2D metal chalcogenides and clays can be assembled, synthesized and processed to afford 3D porous nanostructures.

TABLE 1
Complete parameters of creating CGNs, CMoS₂ and Clay nanosheets.

| Ratio | | | | | | |
|---|---|---|---|---|---|---|
| (DI-H₂O: | | | | | | |
| MeOH) | pH | Temp. | Electric Field | | Flow rate | Morphology |
| 7:3 | 11 | 25° C. | 0.575 | kV/cm | 4 μL/min | Flat & individual Sheets |
| 7:3 | 11 | 100° C. | 0.575 | kV/cm | 4 μL/min | Wrinkles, undulations |
| 7:3 | 11 | 200° C. | 0.575 | kV/cm | 4 μL/min | Wrinkles, partially folded GO |
| 7:3 | 11 | 255° C. | 0.575 | kV/cm | 4 μL/min | Crumpled GO |
| 7:3 | 11 | 255° C. | 0.325 | kV/cm | 4 μL/min | Folded GO with multi layered morphology |
| 7:3 | 11 | 255° C. | 0 | kV/cm | 4 μL/min | Agglomeration of GO films |
| 7:3 | 7 | 255° C. | 0.575 | kV/cm | 4 μL/min | Few layered crumpled GO |
| 7:3 | 4 | 255° C. | 0.575 | kV/cm | 4 μL/min | Agglomeration of crumpled GO |
| 7:3 | 6 | 200° C. | 0.575 | kV/cm | 4 μL/min | Crumpled MoS₂ |
| 7:3 | 11 | 255° C. | 0.575 | kV/cm | 4 μL/min | Crumpled clay nanosheets |

In some examples, 2-D transition metal dichacolgenides and clay nano-sheets have been shown to form crumpled structures when using a collecting substrate with a hydrophobic surface.

Electrohydrodynamic-Stimulated Assembly of Crumpled Graphene Nanostructures

Here we describe the convergence of stimuli-responsive graphene sheets with new insights into the decade-old electrohydrodynamic processes leading to the formation of electrocapacitively active and photoelectrochemically functional crumpled graphene nanoparticles (CGNs). This strategy conceptually mimics charge-stabilized colloidal systems that concurrently introduce electrostatic and capillary cues to initiate a dimensional transition of planar graphene sheets into spherical CGNs comprised of only single-to-few layered walls. We demonstrate that the resultant CGNs and their assembly into microscopic monoliths allows for extraordinary material properties, especially those relevant to energy harvesting and storage, such as high surface area, good electrical conductance, preserved capacity and excellent photochemical properties to be effectively harnessed for macroscopic applications. This general, yet versatile strategy also enables the creation of clay nanosheets, and metal dichalcogenides (molybdenum disulfide, MoS₂) based 3D crumpled structures in tandem with the encapsulation of guest species with dissimilar solubility into CGNs, leading to the formation of hybrid nano-building blocks that can have the advantage of combining the complementary strengths from both chemical worlds.

The deployment of dimensional transitions is ubiquitous in nature, ranging from the Venus Flytrap, beating of a heart, sounds shaped by the vocal folds and zooming of focal length by the human eye. External stimuli in the form of chemical or mechanical cues arising from the environment result in the deformation of materials. Such a dimensional transition leads to new functionalities which cannot be found in their original formats.¹ One of such fascinating examples in molecular material science is carbon. At the molecular level, carbon atoms placed in sp³ tetrahedral arrangement lead to the formation of diamond, the hardest naturally occurring material. In contrast, when pieced together in a planar sp² network, rather soft two-dimensional (2D) graphene sheets are formed that can be re-stacked to create three-dimensional (3D) graphite. On the nanoscale, curled sp² networks lead to strained and deformed structures such as fullerenes and carbon nanotubes. Crumpled graphene nanoparticles (CGNs) are the newest addition to the family and have already stimulated immense interests across different disciplines for widespread applications.²⁻⁵ In particular, 3D particle-like membranes represent a unique type of nano-building block in that they possess distinctly different assembling behaviors from parent graphene by virtue of the weak intermolecular forces that have been known to scale with the geometries between two interacting bodies (i.e., ˜1/d² along with planar surfaces while 1/d⁶ between spheres). Closely resembling metallic lattices, the resulting CGNs, in theory, can be processed in a macroscopic bulk form without significantly compromising the intrinsic material properties, such as high free volume, accessible surface area, and specific capacity.^{2,5-8}

A number of approaches, such as template-directed synthesis, chemical vapor deposition (CVD) over a porous catalyst, and sugar blowing, have been developed to fabricate highly porous, 3D interconnected CGN-like composites.⁹⁻¹¹ However, these strategies all require harsh processing conditions or laborious removal of the sacrificing molds, inevitably introducing complexity and high possibilities to contaminate the functional interfaces.^{6,12,13} While these top-down synthetic approaches hold some promise, it is ultimately a much facile and scalable aerosol assembly that emerges as the most well developed and characterized approach.^{2,4,5,8,14} In essence, solvent evaporation drives the anisotropic crumpling process of graphene containing aerosol droplets.¹⁴ As solvent is rapidly lost, sheets begin to aggregate due to strong intermolecular forces, ultimately clumping into crumpled balls. Although the resultant crumpled balls proved to be compressive resistant and can be packed into high-density configuration, the overall performance is still far from ideal as a result of graphite-like walls. This also in turn generates monolithic materials with less desired properties.¹⁵⁻¹⁷ Thus it is highly desirable to develop strategies that allow us to effectively harness the extraordinary material properties of single-to-few layered CGNs, especially when assembled in a monolithic fashion. Indeed, the ability to reduce the number of layers of CGNs upon assembling into macroscopic composites will not only be crucial for building new types of capacitors, batteries, sensors, and even actuators but also will be paramount for future development of new generations of scaffolds with catalytically active, energetically favorable, and chemically defined interfaces.^{7,18,19}

Recent advances in reduced graphene oxide (rGO), especially new insights into its colloidal chemistry and mechanical properties, open up new avenues to address this formidable challenge.²⁰⁻²² rGO can be well dispersed in water without the need for foreign stabilizers by controlling its surface chemistry.²³ For instance, ionizable edges of rGO were found to be pH sensitive, thus enabling the tuning of surface charge density.^{22,24} Under high pH values, the high negatively charged edges render rGO sheets repulsive with respect to each other, thus preserving the single layer conformation in colloidal dispersions. On the other hand, previous studies on the deformation of rGO sheets also suggest that the seemingly strongest materials on earth can be distributed over a large area when drop casting from rGO dispersions^{7,25-27} and can conform onto curvilinear foreign objects,^{21,28-30} and self-fold into various shapes^{9,28} upon isotropically capillary compression by virtue of the much reduced flexural rigidity.^{7,31,32} Therefore, rGO is indeed a stimulus-responsive, soft material with electrostatically ionizable edges and a mechanically deformable basal plane. We thus surmise that if external stimuli in the form of electrostatic and capillarity-induced-mechanical cues can be concurrently introduced, we may simultaneously tune the colloidal property and strain engineering of rGOs, ultimately transforming into single-to-few layered CGNs with much improved material properties.

In the present examples, we demonstrate the synthesis of mono-to-few layered CGNs and their assembly into multi-functional monoliths through a general, low-cost, rapid and scalable electrohydrodynamic (EHD) process. The resulting CGNs are found to exhibit a combination of high surface area, good conductivity, and largely preserved intrinsic capacity in a bulk form, while the thin and vertically structured walls can be used as energetically favorable 3D scaffolds to facilitate efficient electron transport. In particular, the unique bottom-up and low temperature characteristics of EHD process makes it possible to integrate CGNs onto flexible substrates, such as carbon fiber electrodes, representing a significant step further toward high throughput reel-to-reel production of graphene based flexible electronics. Moreover, incorporating a core/shell spinneret into the EHD approach allows for simultaneous synthesis and entrapment of inorganic guest species with dissimilar solubility into CGNs. This leads to the formation of hybrid nano-building blocks that have the advantage of combining the complementary strengths from both chemical worlds.

General Description of the EHD Process

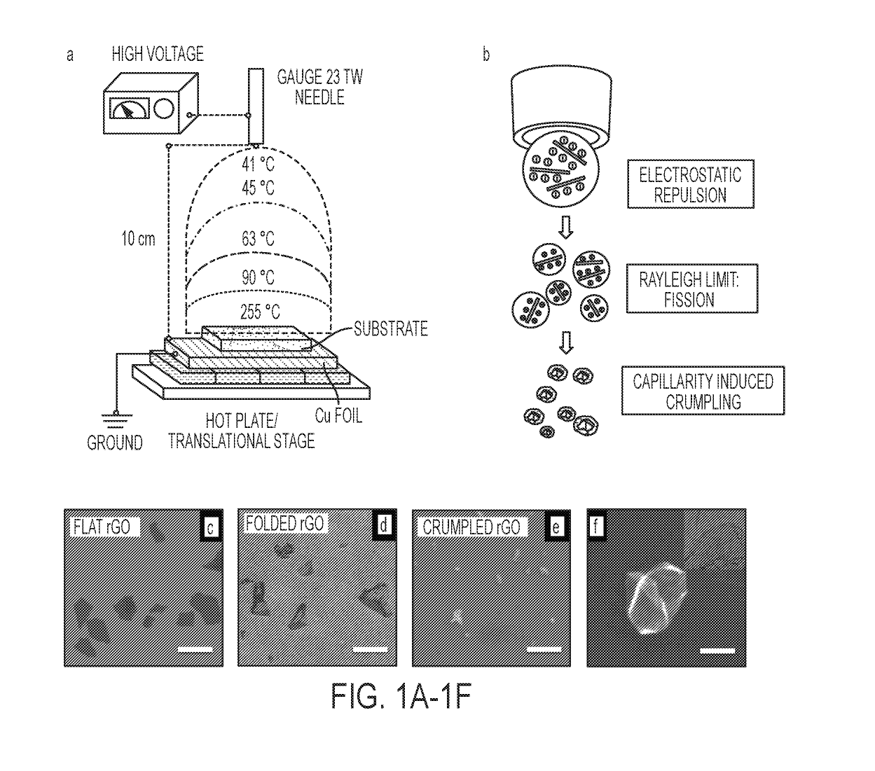

Experiments were performed using a customized EHD setup. A complete diagram of the apparatus is illustrated in FIG. 1A. In a typical experiment, substrates were preheated prior to deposition. To avoid the formation of unwanted coffee ring effects, surface temperature was closely monitored and measured. The feed solution is fed to the spinneret by a syringe pump at a constant feeding rate. Upon reaching a threshold voltage, the liquid meniscus at the end of the needle adapts a conical shape result from the dynamic balance between capillary and EHD normal stresses. A high-speed camera was implemented to closely observe the evolution of meniscus. When a micrometric or nanometric jet disintegrates from the tip of Taylor cone which will eventually break up forming a spray of charged droplets, a homemade shutter is removed from the substrate. The implementation of this shutter mechanism bears a close resemblance to that of thermal evaporation, preventing the deposition of unwanted impurities or large droplets in the initial stage. Deposition yield is found to scale with the concentration of rGO dispersions, flow rate, and duration of EHD process.

Results

Synthesis of CGNs Via EHD Stimuli.

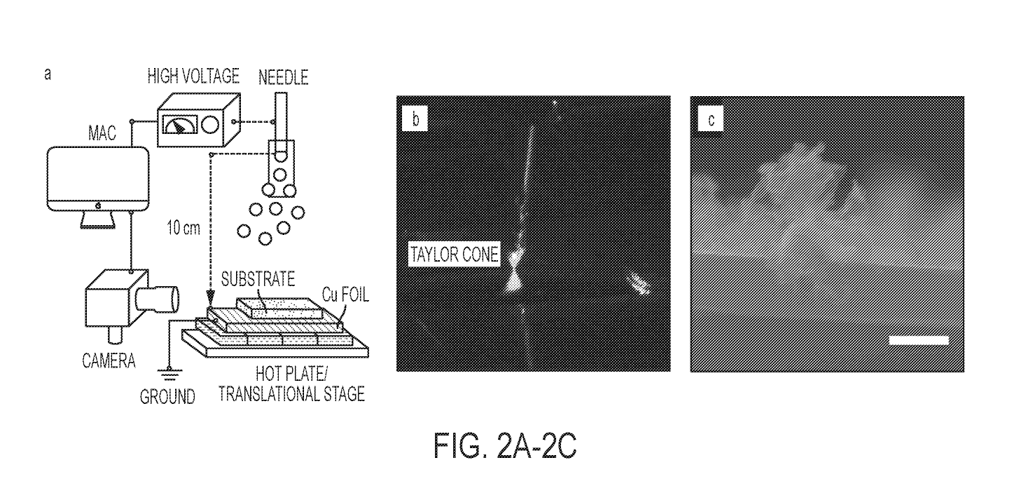

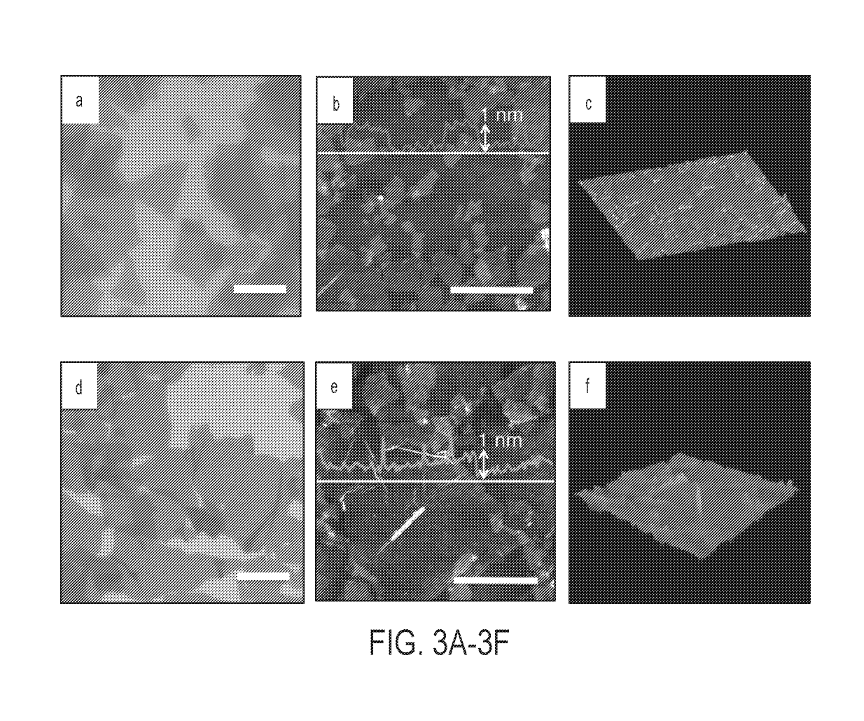

We explored a myriad of approaches and are particularly intrigued by the versatile, readily accessible and scalable EHD process (well known for its use in electrospinning and -spraying, FIG. 1A, and FIG. 2A).³³ For decades, it has been known that the EHD process can atomize liquid mediums for high throughput production of thin film specimens.³⁴ A high voltage applied between the nozzle and a conductive support plate creates an electrohydrodynamic phenomenon that drives the flow of colloidal dispersions out of the nozzle. An ultra-high D.C. voltage (kV) is applied between the nozzle tip and the metal plate using a computer controlled power supply to generate an electric field that causes charged species within the liquid medium to accumulate near the surface of the pendent meniscus. The escalating columbic repulsions between charged species induce a tangential stress on the liquid surface, thereby deforming the meniscus into a conical shape, known as a Taylor cone (FIG. 2B). At a sufficiently high electric field (˜0.575 kV/cm), the electrostatic stress overcomes the capillary tension at the apex of the liquid cone, giving rise to fine, charged droplets. This unique feature can be significantly useful in the case of rGO colloidal dispersions since the highly charged microenvironment first and foremost electrostatically stabilizes rGO sheets owing to the much-enhanced electrostatic repulsion spanning from the needle to collecting substrates. Next, the largest droplet just after separation from liquid jets has a charge density that exceeds the Rayleigh limit.³⁴ At this point, large droplets will undergo a fission process to disseminate into highly charged, self-dispersing droplets with nearly monodispersed diameter distribution in sub-micron to nanometer ranges, as indicated in FIG. 1B.^{35,36} In contrast to the aerosol process where shrinkage of droplets induces the folding of rGO sheets, the fission process readily reduces the loading of rGO sheets in each droplet. In this light, individual fine droplets will only contain a limited numbers of sheets, further reducing the possibility of irreversible aggregation. FIG. 1C shows the representative high resolution scanning electron microscopy (HRSEM) image of spatially separated rGO sheets deposited via EHD process at room temperature. The resultant rGOs appear to separate from each other without agglomerations, underscoring the importance of the electrostatically stabilizing microenvironment. SEM, atomic force microscopy (AFM) and a 3D profile scanned across a myriad of rGO sheets further reveals a step height of ˜1 nm, confirming the single layer identity (FIGS. 3A to 3C). The ability to create single layer rGO sheets not only supports our hypothesis of electrostatically charged nanoreactors but also provides a facile means to obtain single layer rGO specimens for device fabrication through a room temperature EHD process. In some cases, we observed that rGO sheets develop a myriad of wrinkles, especially at the boundaries between neighboring sheets, when the concentration of rGO exceeds 0.5 mg/mL, as shown in FIGS. 3D to 3F. This buckled morphology is likely the result of lateral compressive forces induced via solvent evaporation as opposed to the Maxwell stress stemming from the electromechanical coupling.⁷

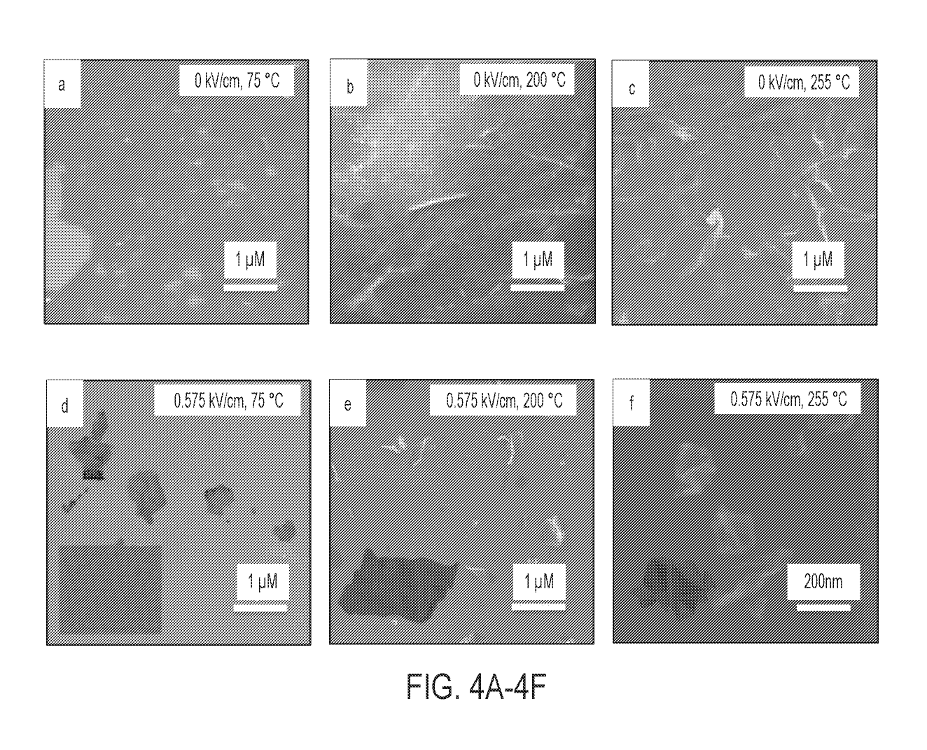

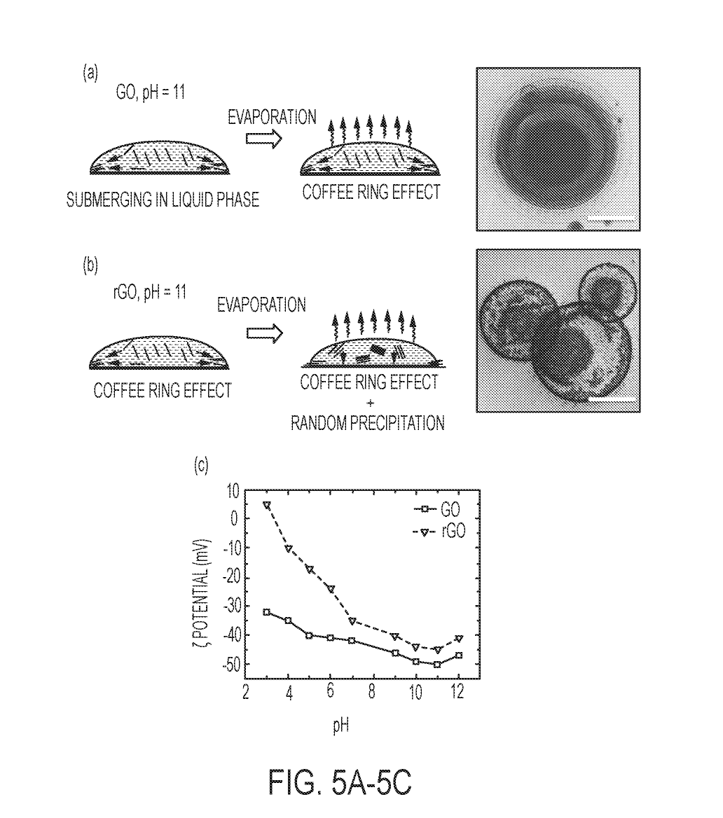

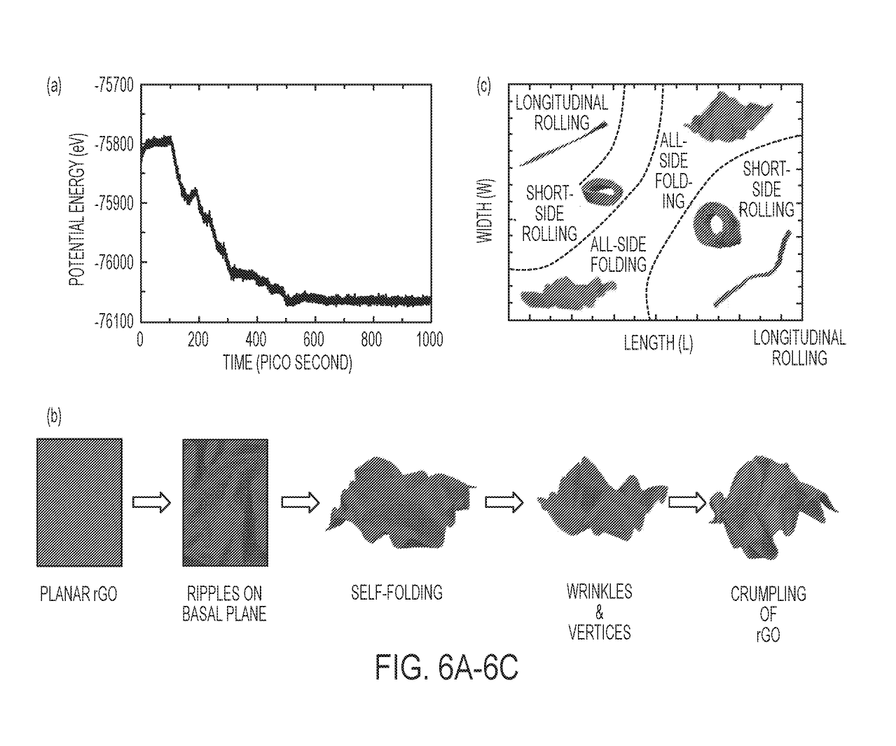

Complete transition of planar sheets into crumples occurred when supporting substrates were annealed at 255° C. using a programmable hot plate. To systematically explore the dynamic interaction between electrostatic and capillary stimuli, SEM images of samples captured along with the spraying pathway under combined effects of a constant electric field (0.575 kV/cm), concentration (50 μg/mL) and flow rate (4 μL/min) permits us to closely monitor the morphological evolution as a function of elevating temperatures. It was discovered that individual rGO sheets, unlike the aggregation seen in aerosol methods, begin to develop a ridge like morphology on the basal plane and folded edges induced by the increasing capillary force when the surrounding temperature is raised to 75° C. (FIGS. 4A-4F). Wrinkled rGO sheets further fold into crumpled nanostructures upon annealing at 255° C. As an explanation for the new crumpled nanostructures, we suggest the loss of electrostatic stabilization. Intuitively, one would expect that the underlying mechanism for crumpling rGO sheets closely resembles that of aerosolized GO nanosheets, e.g., anisotropic capillarity-induced compressive forces. Because of the high surface free energy (˜62.1 mJ/m²) and zeta-potential across the wide range of pH values, GO retains stable dispersions within water droplets unless the coating layer of water is completely removed.³⁷ In other words, the formation of crumpled structures predominately hinges on the rate of desiccation.¹⁴ Indeed, drying experiments of both GO and rGO containing micro-droplets also reveal the distinctive surface activities. Upon drying in the ambient conditions, droplets of GO tends to leave the “coffee ring stain” type of patterns while rGO nanosheets initially forms coffee ring drying marks and then develops into an aggregated morphology due to the loss of electrostatic forces as confirmed in zeta-potential measurements (FIGS. 5A-5C). In rGO dispersions, a greater number of oxygen functional groups are reduced (surface energy of ˜46.7 mJ/m²) and the tuning of surface charges becomes responsible for stabilization. Upon drying, the loss of electrostatic stabilization introduces networks of ridges, ripples, folds and vertices on the basal plane to maximize the overall contacting area, e.g., π-π interactions to suppress the surface tension, thus initiating the deformation process as shown in FIG. 1E.³⁸⁻⁴° Predictions from molecular dynamic (MD) simulation of crumpling rGO sheets in an aqueous medium mesh well with experimental observations as suggested in FIGS. 6A and 6B. The crumpling process is similar in that both use water as dispersing mediums, but is quite independent due to the different driving forces. False-colored HRSEM and TEM provide a close-up view of CGN with an exceedingly thin and semitransparent graphitic wall, presumably due to the dimensional transition from single to few-layered rGOs (FIG. 1F). When the surface temperature of the substrate further rose to 300° C., we noticed that the yield of CGNs decreased significantly. This can be explained by the Leidenfrost effect, for which droplet-substrate contact is impeded by the rapid formation of vapor layers at sufficiently high temperatures. Consequently, the droplets appear to shatter and bounce off of the substrate upon impact, substantially reducing both the fidelity and density of the CGN deposition. Detailed processing conditions can be found in the Methods section, FIGS. 4A-4F, and Table 1, respectively.

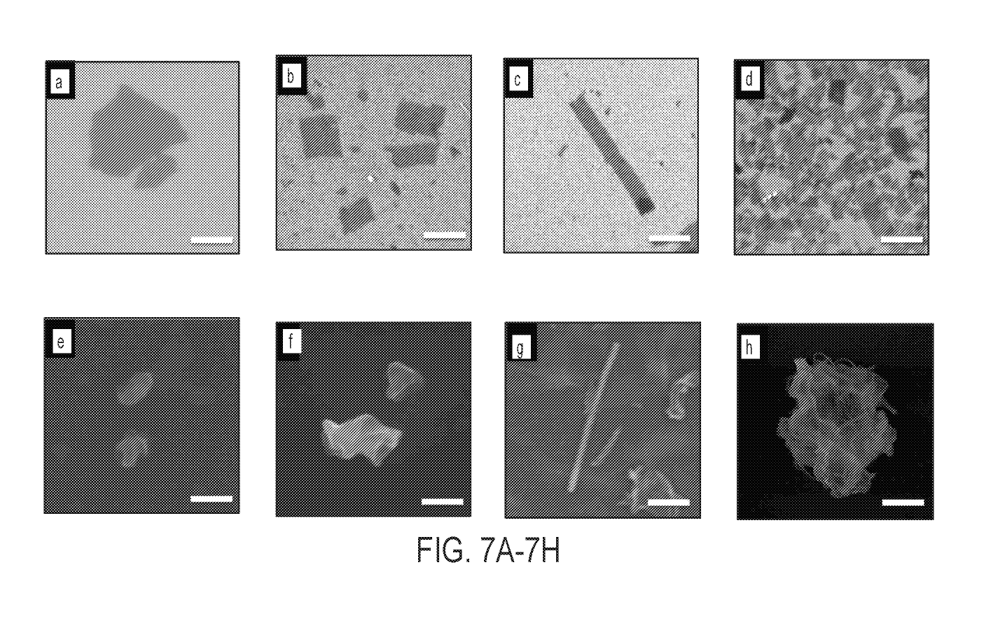

Meanwhile, the radii of the resulting CGNs were found to be relatively smaller than those predicted by theoretical modeling as the harsh chemical exfoliation often introduces high levels of defects on the basal plane of rGO.⁴¹ The rupture of the π-π conjugations not only leads to the reduction of the intrinsic flexural rigidity but makes the CGNs fold or even compress into a tightly packed configurations.⁴ Intriguingly, unlike most of the carbon foams and porous carbon structures that are prone to collapse when subjected to deformation, CGNs maintain a spherical shape and a largely accessible volume even after depositing onto hard substrates as shown in false colored cross-sectional SEM image (FIG. 2C). In addition, it is known that the atomic arrangement at edges of rGOs is distinctively heterogeneous. Any disruption at edges will drive the transformation of rGOs along the preferred facets, thus creating well-defined 3D morphology. To experimentally establish the shape-engineering principle, rGOs with various aspect ratios (l/w˜1.88, and ˜32) were systematically tested using EHD process. A detailed synthesis of shape-engineered rGO precursors is provided below. The experimental observation meshes well with the MD simulation as indicated in FIG. 6C. For example, increasing the aspect ratio of geometrically engineered rGOs causes completely folding dynamics, shifting from folding of all sides (crumples, or sacks) to folding of the short-side or longitudinal rolling (tubes). Indeed, as shown in FIG. 7A-7H, CGNs with a myriad of conformations, including spheres, sacks, tubes, and even a mixture of the three, can be prepared through the chemical tailoring of rGO geometry.^{21,42} The ease of manipulating the final geometry through facile geometrical engineering will allow us to systematically trace the size dependent morphological evolution of CGNs and associated assembling behaviors.

Synthesis of the Geometrically Engineered rGO Sheets.

The aspect ratios of geometrically well-defined rGO sheets can be systematically engineered through the unraveling of commercially available multiwalled carbon nanotubes (MWCNTs) (Kosynkin, D. V. et al. Longitudinal unzipping of carbon nanotubes to form graphene nanoribbons. Nature 458, 872-U875, doi:Doi 10.1038/Nature07872 (2009)). To study the effect of aspect ratios on the final morphology, MWCNTs with various diameters (˜25 nm, and ˜170 nm) were selected. Unzipping of MWCNTs with the diameter of ˜25 nm results in ribbon like rGOs with high aspect ratios (width of 157 nm, length of ˜5 μm, and aspect ratios of ˜32). In contrast, unzipping of MWCNTs with a larger diameter (˜170 nm) often produces rectangular shaped rGOs (width of 1067.6 nm, length of ˜2 μm, and aspect ratios of ˜1.88). To start, a 150 mg portion of MWCNTs was suspended in 36 mL of H₂SO₄ by stirring the mixture for a period of a minimum 1 h to 12 h. Next, H₃PO₄ (85%, 4 mL) was then added, and the mixture was allowed to stir another 15 min before the addition of KMnO₄ (750 mg). The reaction mixture was then heated at 65° C. for 2 h, and then allowed to cool to room temperature before product isolation as described below. The reaction mixture was poured onto 100 mL of ice containing H₂O₂ (30%, 5 mL). The product was allowed to coagulate (no stirring) for 14 h. The top portion was decanted from the solid, and the remaining portion was filtered over a 200 nm pore size PTFE membrane (5 μm pore size also works). The brown filter cake was washed 2 times with 20% HCl (20 mL each), re-suspended in Acetone (60 mL). The product was filtered on the same PTFE membrane and then dispersed in ethanol (100%, 40 mL) for 2 h with stirring, followed by filtration. The resulting solid was dispersed in a mixture of H₂O and MeOH (v/v, 9:1) in a 1 mg/mL ratio and sonicated for 1 hour. Subsequently, the mixture was placed inside the hood overnight. Decant the supernatant and then centrifuge at 2,000 rpm for 1 hour to further remove any agglomerations.

Conformational Evolution of CGNs Through Geometrically Engineered rGO Sheets

MD simulations were performed using LAMMPS software (Plimpton, S. Fast Parallel Algorithms for Short-Range Molecular-Dynamics. J Comput Phys 117, 1-19, doi:Doi 10.1006/Jcph.1995.1039 (1995)). The initial geometry of rGO configurations were optimized using the conjugate gradient method and the folding simulations were conducted with a time step of 1 fs. The crumpling process of the relatively hydrophobic (lower surface energy) rGO sheets can be deemed as a process to minimize the mechanical instability in colloidal dispersions. In particular, the presence of water is expected to change the folding dynamics of CGNs as rGO sheets will first self-fold to increase the contact area of π-π interactions which scale with van der Waals (vdW) forces, thus minimizing the overall potential energy (E) (Patra, N., Song, Y. B. & Kral, P. Self-Assembly of Graphene Nanostructures on Nanotubes. Acs Nano 5, 1798-1804, doi:Doi 10.1021/Nn102531h (2011); Qin, Z., Taylor, M., Hwang, M., Bertoldi, K. & Buehler, M. J. Effect of Wrinkles on the Surface Area of Graphene: Toward the Design of Nanoelectronics. Nano Lett 14, 6520-6525, doi:Doi 10.1021/N1503097u (2014); Tang, C., Oppenheim, T., Tung, V. C. & Martini, A. Structure-stability relationships for graphene-wrapped fullerene-coated carbon nanotubes. Carbon 61, 458-466, doi:Doi 10.1016/J.Carbon.2013.04.103 (2013)). From an energetic point of view, the crumpling dynamics in this case can be briefly expressed as the competition between van der Waals energy (E_{vdW}) and elastic bending energy (E_{bend}). In the former case, E_{vdW} scales with the contacting area while E_{bend} predominately hinges on the aspect ratios. While the presence of water is expected to change the rate at which folding or wrinkling occurs on the hydrophobic basal plane, the aspect ratios of the rGO sheets derived from chemically unraveling of MWCNTs will likely dominate the preferred direction of folding. In other words, the final geometrical conformation of these freestanding rGO sheets can be controlled by the length-to-width ratio on the preferred direction of folding. As shown in our previous study, E_{bend} increases with rGO size, and the rate of that increase is faster with width than with length. In addition, the energy ratio between bending from longitudinal and width direction derived from the MD simulation sheds lights on predicting the energetically favorable direction for folding (Tang, C., Oppenheim, T., Tung, V. C. & Martini, A. Structure-stability relationships for graphene-wrapped fullerene-coated carbon nanotubes. Carbon 61, 458-466, doi:Doi 10.1016/J.Carbon.2013.04.103 (2013)).

E_{bend}^{L}/E_{bend}^{W}=0.34w−2π(R+1.35)²/0.34l+2π(R+135)² (1)

where w is the width, and l is the length of rGO. R is radius of the supporting substrates and will not be used in calculation since rGOs are freestanding. It becomes apparent that when w<l, the ratio of E_{bend}^{L}/E_{bend}^{W} is less than unity, suggesting that rGO will be energetically prone to bending along the L direction (tubular structures). With decreasing aspect ratios (w>l), the energy ratio dramatically reduces, leading to the formation of short side rolling and all side folding as shown in the schematic diagram of folding as a function of length and width.

Characterization of CGNs.

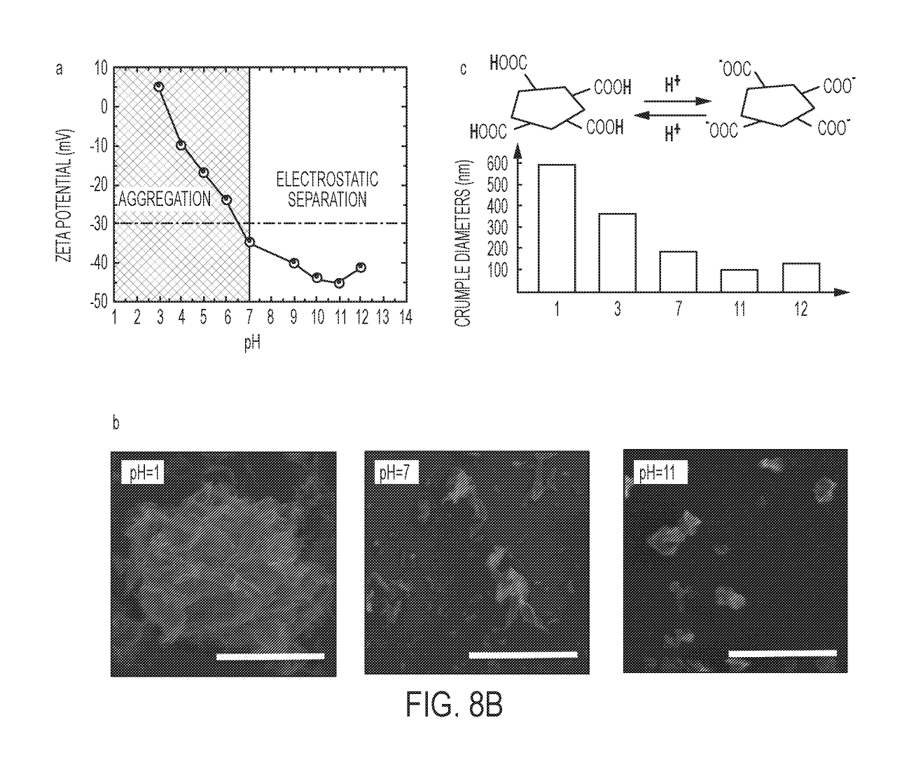

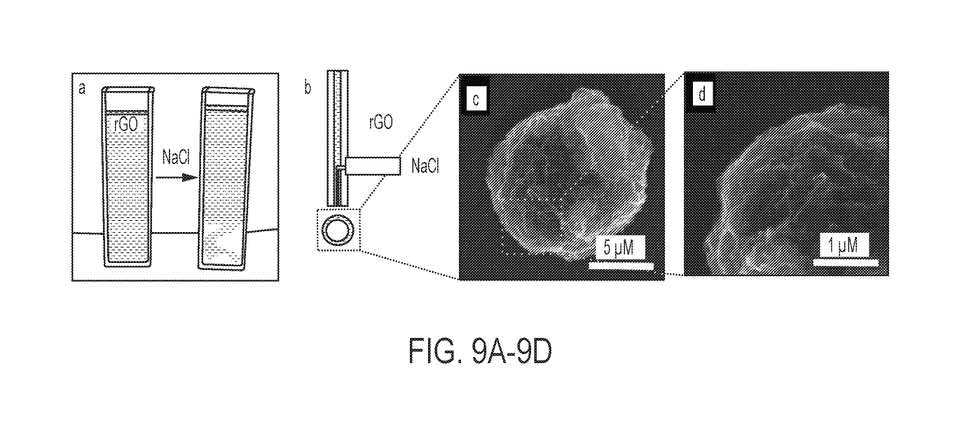

Similar to many rGO based colloidal experiments, including our previous work on counter ion stabilized rGO-hydrazine dispersions, the stability of the electrostatically charged colloidal microenvironment strongly hinges on pH, the content of dispersants, and the concentration of electrolyte.^{22,24,43} Among these variables, pH value plays a vital role by drastically altering the surface charge density (Zeta potential) of rGO sheets as it affects the degree of ionizable carboxylic groups. FIG. 8A summarizes the Zeta potential of rGO dispersions as a function of progressively increasing pH. At low pH, rGO becomes less charged and tends to agglomerate due to the strong π-π intermolecular forces that overshadow the electrostatic stabilization, adversely suppressing the fission process. As a result, rGO sheets directly clump together into a closely packed sphere with dimensions well extended into sub-microns and to tenths of microns, analogous to those made of aerosol assembly. Meanwhile, when volatile ammonia is slowly added into the rGO dispersion, zeta potential decreases monotonically and reaches its zenith of −47 mV at pH 11. It is known that surface charge below −30 mV (pH >7) is considered a prerequisite for sufficient mutual repulsion of rGOs, ensuring the stability of colloidal dispersion.⁴⁴ Indeed, largely aggregated rGO clusters start breaking up into smaller aggregates at pH 7 and further disintegrate into discrete CGNs at pH 11 as shown in FIG. 8B. The evolution of CGN dimensions under a myriad of pH values is summarized in FIG. 8C. In addition, the colloidal nature of the electrostatically charged nanodroplets is further confirmed by two experiments typically conducted in colloid science: High Order Tyndall (HOT) effect and the salting effect. In accord with the HOT effect, the highly conductive fine droplets exhibit a discernable combination of colors when they are illuminated with white light as a result of light scattering.⁴⁵ In another typical lyophobic colloid stabilized through electrostatic repulsion, adding an electrolyte solution such as sodium chloride (NaCl) induces immediate and irreversible coagulation (FIG. 9A). We have observed the similar trend in our modified EHD set up. To test the macroscopic salting effect in the nano-scaled colloidal droplets, we adopted the coaxial needle configuration that enables mixing of both precursor solutions just before they are forced to break into fine nanodroplets as schematically depicted in FIG. 9B. SEM images conclusively substantiate the hypothesis as rGO sheets suspended in nanodroplets form large agglomeration with heavily wrinkled surface morphology right after mixing with NaCl solution at the liquid-liquid interfaces as shown in FIGS. 9C and 9D.

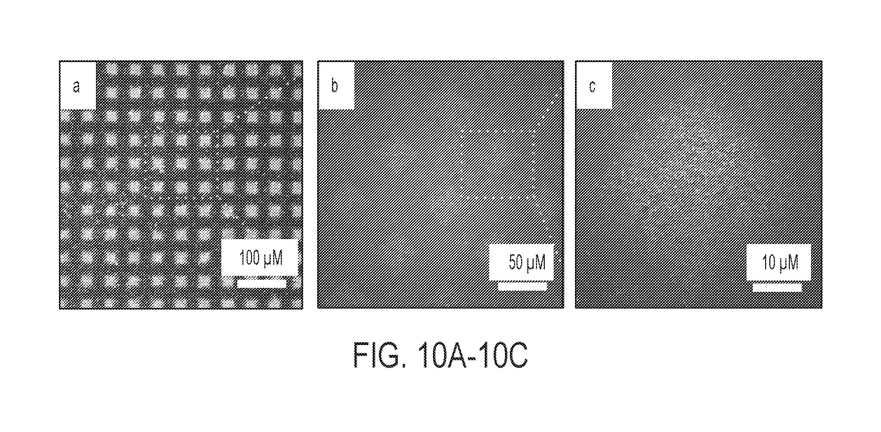

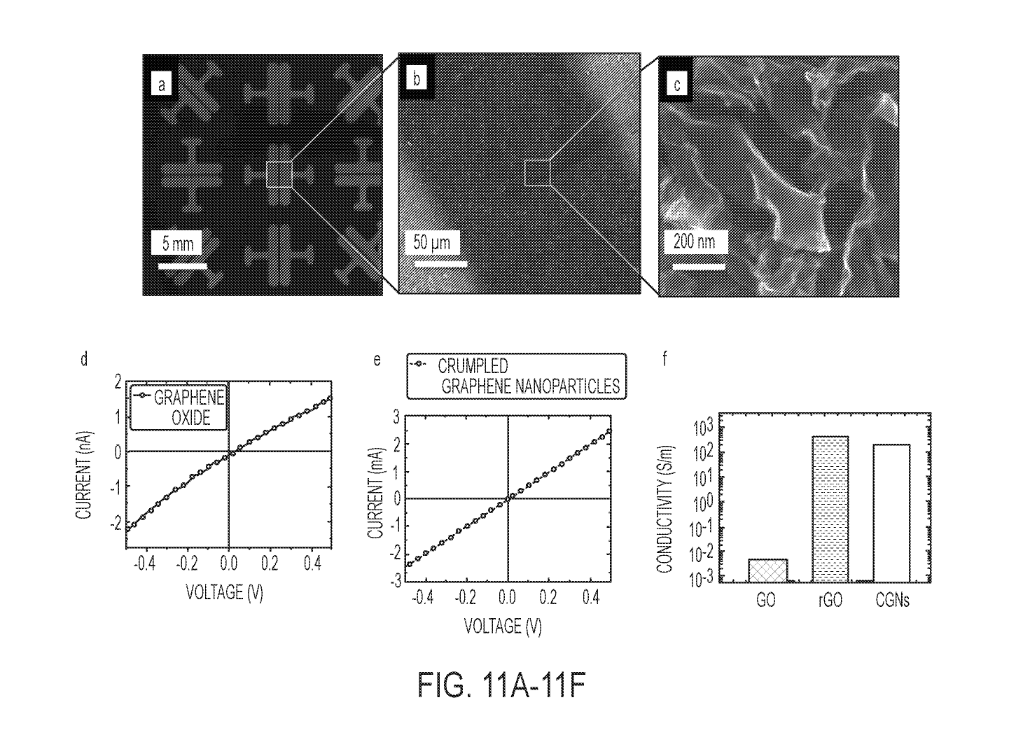

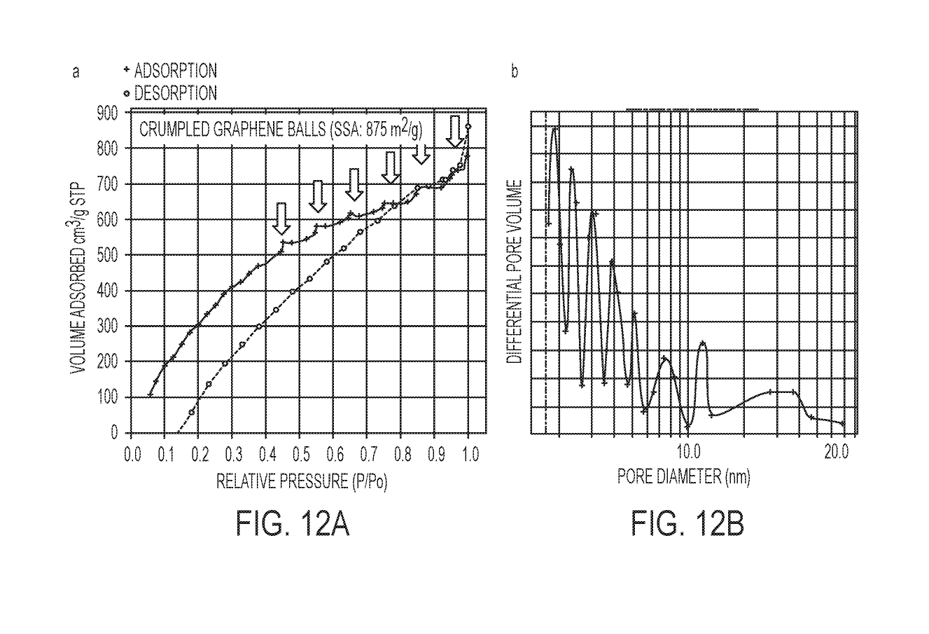

Synergistic combination of the stimuli responsive nature of rGO and external stimuli arising from the electrohydrodynamically generated droplets unlocks a new approach to harness superlative material properties at the nanoscale for microscopic integration and macroscopic applications. While the 2D configuration of rGO is well suited for constructing electrically conductive, and spatially interconnected networks, it is the propensity to aggregate when processed in a bulk form that adversely affects permeability, ionic transport, accessible surface area and most importantly the intrinsic capacity.¹⁹ On the contrary, the EHD process reported here alleviates the geometry dependent constraints for the effective and direct assembly of highly conductive yet porous monoliths. Large-area CGN deposition is made possible by employing a “multi-pass” technique. After iterative cycles of deposition, densely packed CGN assemblies were found to uniformly distribute throughout the entire substrates. Alternatively, CGNs can be selectively registered in a way similar to mask-assisted photolithography. Upon deposition, the motion of the charged droplets can be preferentially guided (including deflection or focusing) by a directional electric field, enabling simultaneous transformation and selective patterning of CGNs monoliths. FIGS. 10A-10C features arrays of well-defined, rectangular patterns of CGN monoliths obtained through the assistance of a commercially available earphone mesh as a mask. The fidelity and variety of the patterns can be further improved when combining with the computer programmable translational stages. Of particular importance, the ease of creating monoliths of CGNs also allows us to investigate the electrical properties by means of thermal evaporation to provide gold source-drain top contacts. FIGS. 11A-11C provide a series of optical and SEM images of our design with electrode separation channel lengths of 200 μm. The conductivity of CGN networks is found to be ˜2.13×10³ S/m which is comparable to that of laser-scribed or liquid-mediated rGO papers, confirming the establishment of conductive pathways.^{46,47} FIGS. 11D-11F show the output curves for parent GO, rGO, and our CGNs, respectively. As expected, the bulk assembly of CGNs delivers a drastic enhancement of 6 orders of magnitude when compared to that of insulting GO papers. In parallel, the CGN monoliths possess hierarchically porous structures at different scales, including interconnected micro-porous networks made of nano-porous CGNs with polydispersed distributions of diameters. As a result, the bulk assembly of CGNs closely resembles the 3D strutted foams that exhibit a combination of high surface area (875 m²/g) measured by the Brunauer-Emmett-Teller (BET) approach and diverse porosities as shown in Barret-Joyner-Halenda (BJH) calculation (FIGS. 12A and 12B).¹⁰ The intriguing structural diversity found in our CGN based monoliths is in stark contrast to those crumpled balls made of multi-layer sheets, which are likely to block the available adsorption sites, thus adversely affecting the accessible surface area, blocking ionic channels and reducing the intrinsic capacity, respectively. The prospect of harvesting these compelling material properties makes CGN monoliths well suited for an active component for electric double layer capacitor (EDLC) application.

3D Interconnected CGN Monolithic Capacitors

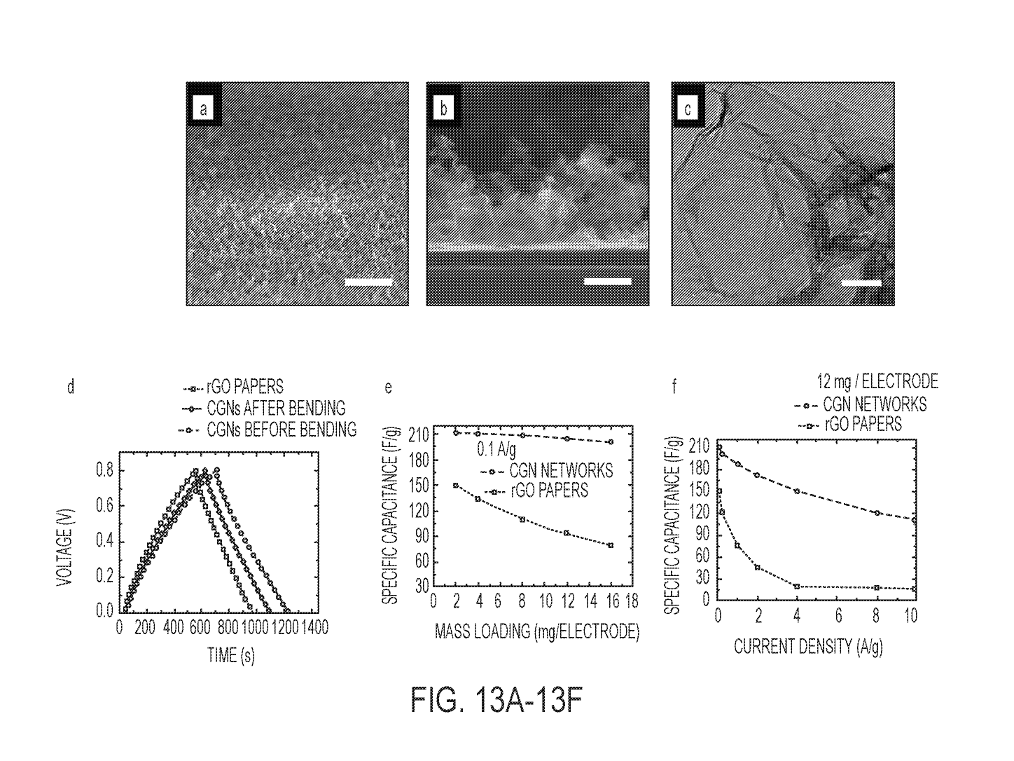

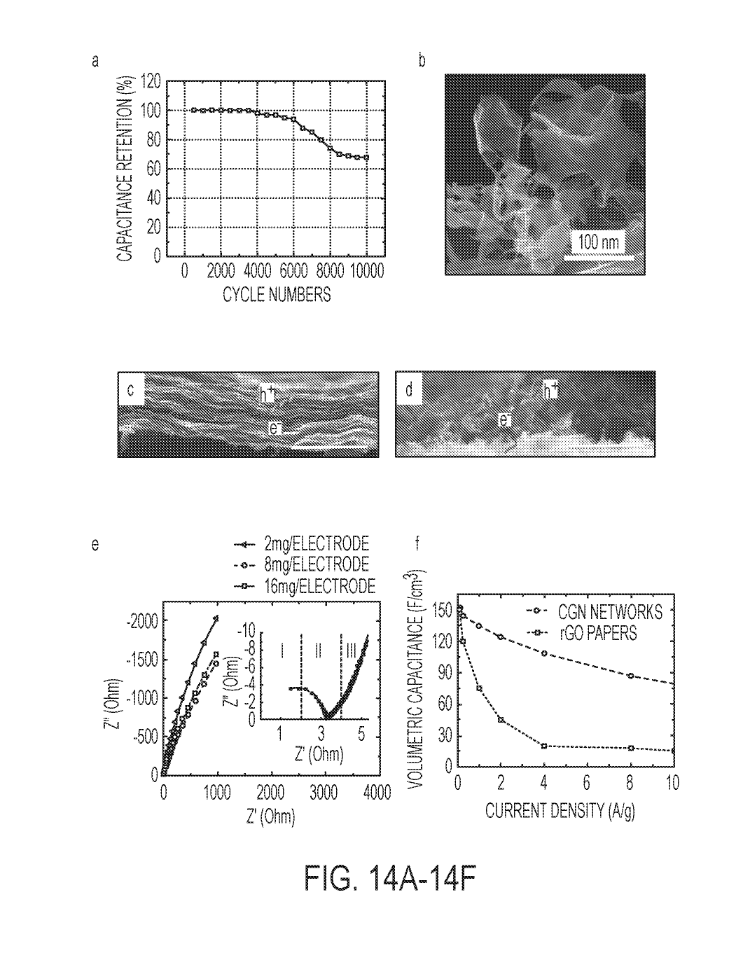

To this end, an ultracapacitor using CGN monoliths obtained through EHD spraying was examined by a symmetrical two-electrode coin-cell configuration. Cells can be directly configured as collecting substrates because the conductive stainless steel electrostatically guides the preferential deposition of CGNs. It is noted that a thin corrugated rGO papers made by room temperature EHD process was employed as conductive scaffolds to further enhance both the efficiency and density of CGNs. Thickness of the CGN monoliths was controlled by the parameters, e.g., concentration, deposition time, and flow rate, of EHD deposition. In a typical deposition to achieve a thin film thickness of 10 μm, a solution of rGO (concentration 50 μg/mL; pH 11; electric field of 0.575 kV/cm and flow rate of 4 μL/min) was continuously sprayed via the automated EHD process for 60 to 80 hours. Note that the throughput can be readily scaled up via using multiplexing nozzles.³⁴ Upon continuous deposition, the initially loose and sporadically distributed CGNs gradually transform into spatially connected, structurally adaptable and tightly packed monoliths as shown in tilted (FIG. 13A) and cross sectional views (FIG. 13B). TEM image further provides a close-up view of various CGNs joined by corrugated or folded walls at the edges as indicated in FIG. 13C. 5 M KOH was used as the aqueous electrolyte to rule out the overestimation of intrinsic capacitance as a result of unwanted reactions between oxygen remnants and acidic electrolytes.⁴⁸ FIG. 13D shows the output galvanostatic characteristics under a constant current of 0.1 A/g. Both planar rGO papers and CGN monoliths displayed nearly isosceles triangle shaped curves, confirming the EDLC characteristics of the specimens. The collective gravimetric capacitance (C_{wt-C}) of CGN monoliths and rGO paper were measured to be 210 and 145 F/g, respectively, when characterized under a mass loading of 2 mg/electrode and current density at 0.1 A/g. Both specimens exhibit stable C_{wt-C} values upon few thousand rounds of charge/discharge cycles. Meanwhile, the Columbic efficiency was also found to be close to unity. We also observed that the CGN monoliths can surprisingly sustain iterative compression, and bending at 60° without significant loss of capacitance for the initial four thousand cycles although the capacitance retention monotonically drops from >95% to 68% after 10,000 cycles due to the detachment of CGNs in the top layers (FIGS. 14A and 14B). Nevertheless, this is still intriguing as no binder, e.g., PTFE, was used to mechanically glue the neighboring CGNs. We attribute the enhanced structural integrity to a foam-like hierarchical structure. On the top level, the relatively soft and thin walls of initially spherical CGNs are deformed and readily adapt a close-packed polyhedral structure as a result of the downward gravitational force, emulating the coalescence of two droplets where a temporary meniscus bridge will form.⁴⁹ On the bottom level, the CGNs are further compressed into an ordered, structurally rigid and largely corrugated multilayered configuration, further maximizing the π-π interaction between each cell wall and the overall structure. This collectively increases the elastic modulus and ultimately strengthens the porous structure to withstand a severe bending deformation.

The binder-free feature also manifests in improved ion flow and electron transport for increased mass loading. Unlike the rGO counterpart, where the ion flow and transport of electrons are normal to the direction of stacking sheets, free space inside and between neighboring CGNs synergistically establishes dual pathways for ion flow while the seemingly joined walls facilitate efficient electron transport pathways, closely resembling the holey graphene based composites albeit in a 3D configuration (FIGS. 14C and 14D).^{19,50-52} FIG. 14E features the mass loading dependent electrochemical impedance spectroscopy (EIS) recorded at an operation range of 10³ to 10⁻² Hz around open voltage (AC oscillation voltage of 5 mV.) All three samples made of different mass loadings display nearly identical responses, especially in the high to medium frequency range. The inset of FIG. 14E shows that the ohmic resistance of the ultracapacitor (section I), which is the first intersection with the real axis in tandem with semicircles that corresponds to charge transfer (section II), remains constant with an increased mass loading of CGNs due to the continuous shuttling of ions into the electrode interior during the charge/discharge process. However, at the lower frequency region (section III), transition from a high slope tail beyond the semicircle to a smaller slope is observed and becomes slightly more pronounced when the mass loading increases, indicating a possible retaining of electrolytes. This can be ascribed to the bottom level of CGN monoliths that tend to compress in parallel, leading to slightly higher diffusion resistance and thus a smaller slope. Nevertheless, the above frequency responses indicated that the mechanically robust, ionically favorable, and electrically functional pathways embedded within CGN monoliths remain largely intact after infiltration of electrolytes. The importance of establishing such ionic transport pathways is further evidenced by the effect of aerial mass loadings. When packed with high mass loadings, C_{wt-C} generally decreased. FIG. 13E shows the C_{wt-C} of CGN monoliths and rGO papers as a function of increasing mass loadings. Similar to other porous carbon based nanocomposites, of both specimens degreases with thickness. However, CGN monoliths deliver a nearly constant output of C_{wt-C} between 210 to 198 F/g while rGO papers drop significantly from 145 to 88 F/g at a low current density of 0.1 A/g. The depreciation of the C_{wt-C} becomes even more pronounced when operating under high current density. Increasing current density incrementally from 0.1 to 10 A/g drastically decreases the C_{wt-C} of rGO papers to 25 F/g at areal mass loading of 16 mg as illustrated in FIG. 13F. On the other hand, the hybrid CGN monoliths characterized at 10 A/g display a much slower rate of decrease, delivering C_{wt-C} of 118 F/g.

A similar trend is observed in the volumetric capacitance (Cᵥₒₗ). As with most of 3D graphene foams, the once advantageous properties, such as high surface area and porosity, adversely affect the packing density. Although aerosol assembled crumpled balls can be tightly packed into electrode stacks, it is the irreversible clumping of rGOs that generates hard and rigid textures prevents preferential packing in the densest fashion. This leads to a relatively low packing density (˜0.5 g/cm³) when compared to the rGO papers (˜1 g/cm³)^{3, 47} As shown in the previous section, the shape-adaptable CGNs can be deformed into non-spherical, polyhedral shapes under gravitational compression, mimicking the assembly of individual bubble cells into foams in a highly dense-packing fashion. This leads to the increase of overall packing density of CGN monoliths to be as high as 0.68 g/cm³ and 0.62 g/cm³ on average. As a result, the corresponding Cᵥₒₗ of CGN monoliths remains relatively high when compared to that of the rGO counterparts as summarized in FIG. 14F. More importantly these structurally advantageous features of CGN monoliths hold great promise and will likely inspire new design of next generation graphene-based EDLC. One possible avenue is the convergence of morphological merits from both rGO paper and CGN monoliths, thus leading to the formation of cardboard like composite films embedded with alternating layers of micro-corrugated sheets separated by CGNs, simultaneously enhancing the structural integrity (e.g., suppressing the detachment of CGN monoliths upon mechanical deformation), packing density, surface area and ionic transport conductivity without compromising the intrinsic capacitance, ultimately giving rise to a much-improved power density.⁴⁷

3D Interconnected CGN/TiO₂ Photoanodes

The tantalizing utility of these CGNs is further demonstrated by their successful integration as vertically extended, and energetically favorable 3D scaffolds for photoanodes in photoelectrochemical (PEC) applications. A formidable challenge in achieving competitive power conversion efficiency is the efficient transport of electrons across the entire photoanode. Thus far, nanostructured titanium dioxide (TiO₂) represented the widely used material system because of their commercial availability and solution processability. Unfortunately, the spatial distribution of grain boundaries throughout the particulate TiO₂ layers imposes energetic hurdles for charge carriers, leading to increasing numbers of recombination and trap sites. While the 2D graphene derivatives, including both GO and rGO, have been extensively used to improve electrical contacts, and energetics at interfaces for quite some time, sheets tend to aggregate during co-assembly with TiO₂ nanoparticles, thus leading to the formation of metal-semiconductor Schottky junctions.^{53,54} ENREF 46 In addition, multilayers of horizontally stacking graphene sheets is detrimental to the carrier transport, which prefers the direction perpendicular to the current collecting electrodes. As a result, the overall performance still falls short of the crystalline TiO₂ counterparts. In this light, to form continuous pathways for efficient carrier transport, it is highly desirable to assemble rGO modification layers with thicknesses of just 1-2 monolayers while percolating within the nanostructured TiO₂ active layers to ensure sufficient vertical conductivity. 3D CGNs should be well suited to address this challenge. Unlike the lamellar counterparts, the non-planar contour of CGNs first and foremost suppresses the formation of unwanted Schottky junctions while the thin and vertically protruded walls that well extend into hundreds of nanometers align well with the flow of electrons.

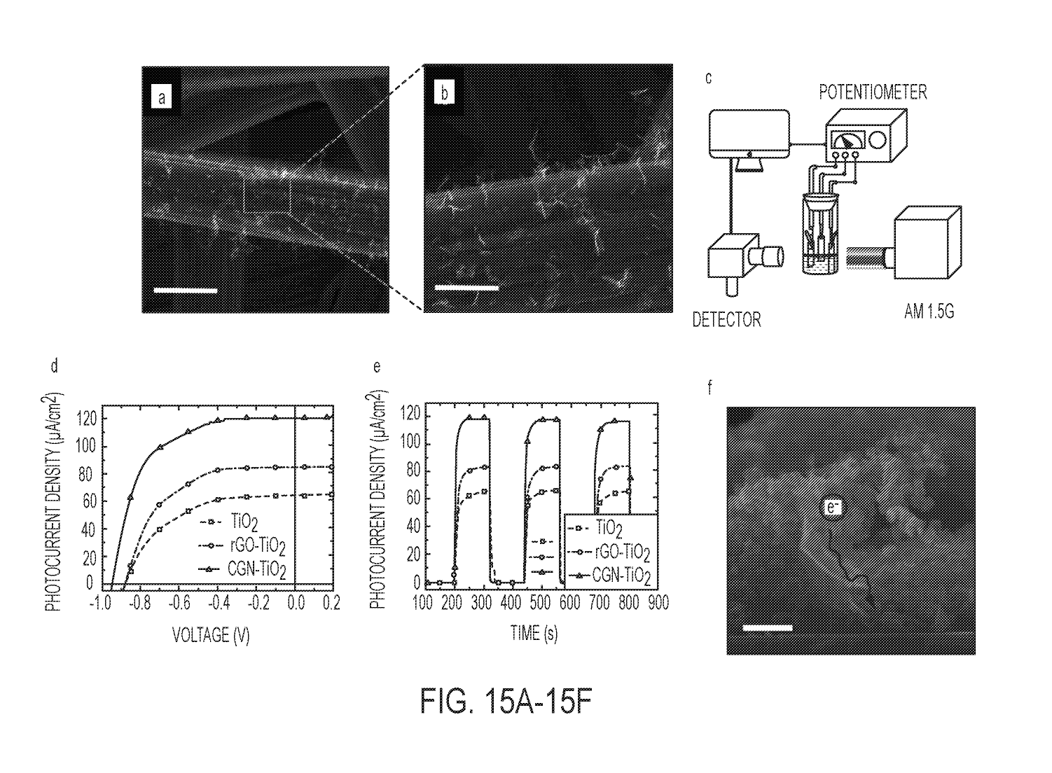

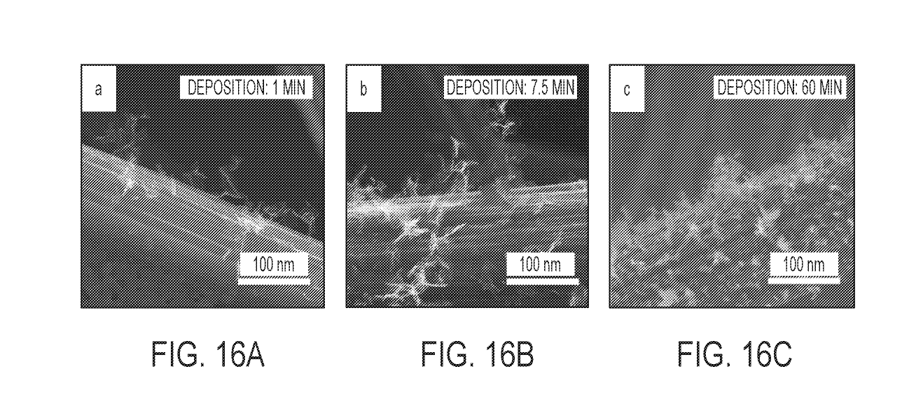

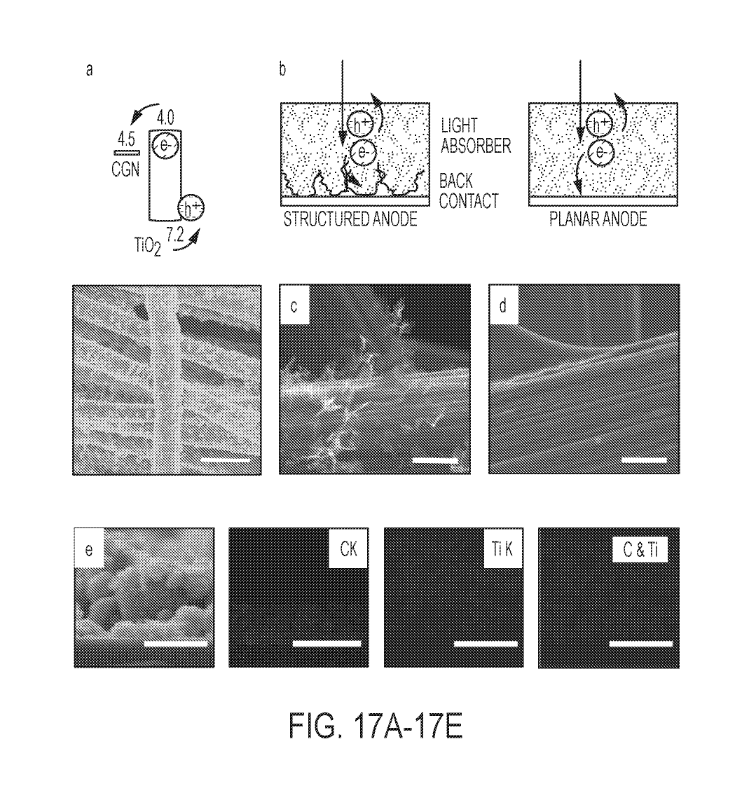

Indeed, the versatile CGNs can be readily configured as 3D textured scaffolds with energetically favorable interfaces for TiO₂ nanoparticle based photoanodes through substantially improving both carrier diffusion and collecting efficiency. CGNs with varied spatial distribution and densities can be simply obtained by adjusting the concentration of the starting rGO dispersion in tandem with the deposition time. Flexible and conductive carbon fiber electrodes (CFEs) were used as both the modification layer and the current collecting substrates. CFEs have been used as the back contact because of their highly conductive, chemically inert and mechanical robust nature.⁵⁵ HRSEM images reveal the formation of CGN based scaffolds as shown in FIGS. 15A and 15B. A combination of deposition time (˜7.5 to 8 minutes), concentration of rGO (50 μg/mL), electric field (0.575 kV/cm), and flow rate (4 μL/min) was found to deliver the most optimized morphology, with an annealing temperature maintained at 200° C. to afford more structurally open morphology of CGNs. The density of CGN scaffolds can be systematically engineered through the deposition time as shown in FIGS. 16A-16C. Next, a dense layer of TiO₂ nanoparticles with thickness of around 3 μm was directly casted on top of the 3D CGN scaffolds as the light absorbing material. FIG. 17A shows that the coating of TiO₂ nanoparticles is conformal and uniform throughout the active area, providing effective harvesting of photons. FIG. 15C schematically illustrates the setup of PEC measurements comprised of an AM 1.5 G solar irradiation, a three-electrode configuration equipped with TiO₂ based working electrode, Pt counter electrode and Ag/AgCl reference electrode immersed in an aqueous 1.2 mM KOH electrolyte solution in tandem with a potentiometer. FIG. 15D shows the representative current-voltage output characteristics of TiO₂ only (red line), planar rGO/TiO₂ (blue line) and 3D CGN/TiO₂ photoanodes (black line), respectively. Upon illumination, all three photoanodes exhibit increasing current densities as oxidation of water takes place on the photoanode. The pristine TiO₂ nanoparticle electrode shows a typical photoresponse, with short circuit current (J_{sc}) of 60 μA/cm², fill factor (FF) of 65% and an open circuit voltage (V_{oc}) of 0.88 V, whereas the 3D CGN/TiO₂ based electrode yields a much-enhanced J_{sc} of 120 μA/cm², FF of 70% and V_{oc} of 0.95 V. At open circuit condition, the enhancement of J_{sc} with respect to 3D CGN/TiO₂ photoanode is more than 2 times greater than that of TiO₂ alone. In particular, the 3D CGN/TiO₂ composites also show a steeper increase in the photocurrent with applied voltage, suggesting electron and hole pairs induced by photon absorption split more readily compared to particulate counterparts. We note that the output characteristics of our 3D CGN/TiO₂ photoanodes are comparable to those made of atomic layer deposition (ALD) grown TiO₂ on Si.⁵⁶ This greatly relaxes the constraints of complex ALD process and allows the use of cost-effective and readily available TiO₂ nanoparticles.

As for the planar rGO/TiO₂ case, the metal-semiconducting Schottky contact primarily accounts for the electron transport. Although both CGNs and rGOs exhibit similar work function around 4.5 eV (FIG. 17A) experimentally determined by ultraviolet photoelectron spectroscopy (UPS), the planar rGO/TiO₂ electrode displays a moderate increase of J_{sc}, presumably due to the surface modification between TiO₂ nanoparticles and CFEs.⁵⁷ The magnitude of the photocurrent generation is further examined through pulse photocurrent response as a function of time (FIG. 15E). In accordance with the current-voltage output, 3D CGN/TiO₂ photoanodes show greatly enhanced, prompt and reproducible photoresponses that can be translated into improved charge collection efficiency at the electrode/electrolyte interfaces. Of particular interest is that the interfacial characterization conducted here underscores the importance of high aspect ratio architecture inherent in the 3D CGN scaffolds that help to minimize the possibility of creating graphite like shunting pathways^{53,54} as well as the shortening diffusion length within particulate TiO₂ electrodes. As illustrated FIG. 17B as well as cross-sectional SEM images from FIGS. 15F, 17C and 17D, in the proximity of every dissociated electron there is a vertically percolated graphitic pathway where transport takes place. Such vertical transport pathways are further spectrally confirmed by the energy dispersive x-ray (EDX) mapping which reveals the spatial distribution of relevant elements within the composites (FIG. 17E). Accordingly, electrons can immediately propagate to the collecting electrodes without circumventing energetic barriers between grain boundaries. Indeed, the much improved transport characteristics give rise to a comparable J_{sc} on par with those made of a 15 μm thick film of TiO₂ nanoparticles on Ti foil under the same illumination conditions.⁵⁸ The rational design of 3D nanostructured CGN scaffolds presented here also represents a visible nexus to many emerging flexible electronics for energy harvesting applications, such as all-solution processed flexible perovskite photovoltaics, where the formidable challenge is the requirement of both high temperature sintering process and ultrahigh vacuum conditions for crystalline TiO₂ layers.⁵⁹⁻⁶¹

### DISCUSSION

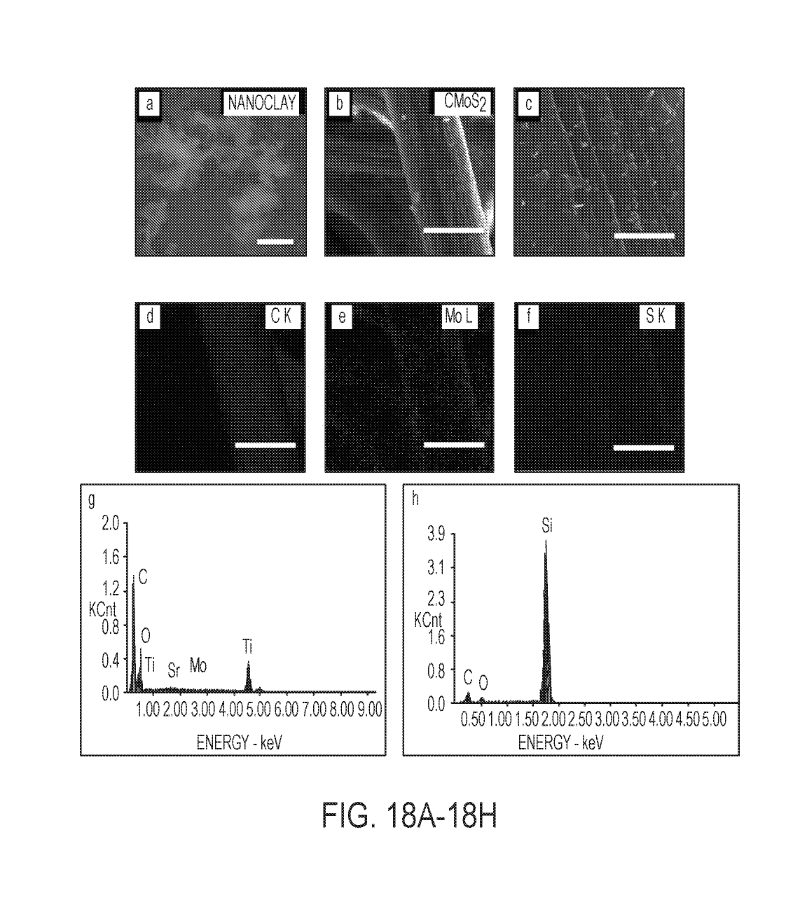

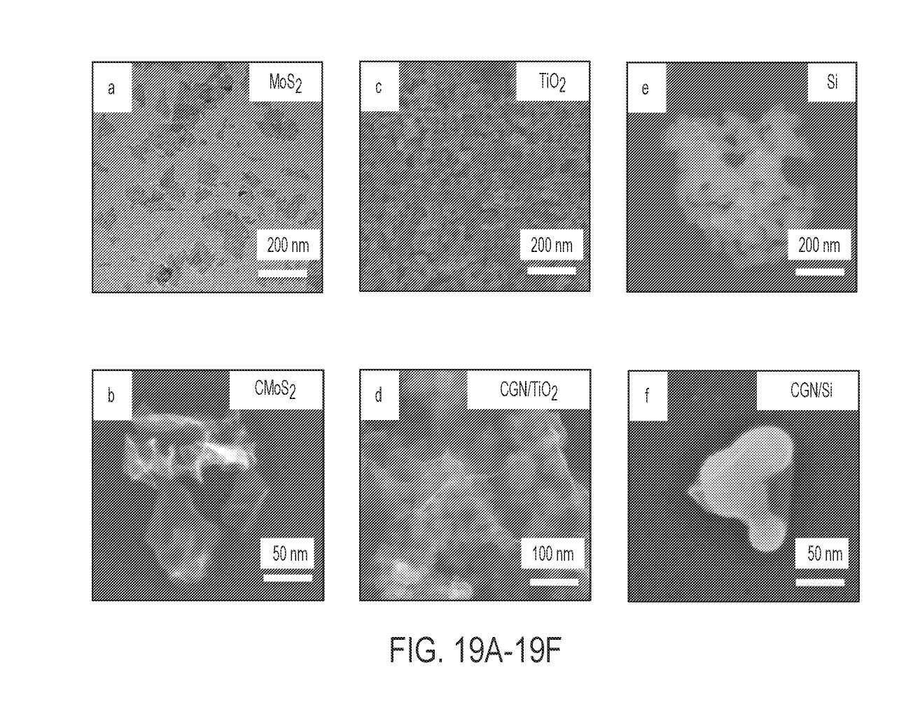

The combination of electrostatic and capillary cues stemmed from EHD processes collectively helps to decouple those exceptional properties from the layer dependent electronic structures of graphene derivatives when processed in a bulk form. This embodies an important step to end the chasm between academic prototype and industrial implementation of graphene based composites where the difficulties lie in the design of a hierarchically functional architecture that allows for extraordinary material properties of individual sheets to be effectively harnessed.⁶² Further, the EHD strategy reported here should be universal and applicable to many emerging inorganic 2D sheets. Indeed, we have achieved the dimensional transition of clay nanosheets (CNS), and molybdenum disulfide (MoS₂). As shown in FIG. 18A, soft CNS self-folded into highly wrinkled, porous structures while relatively rigid MoS₂ nanosheets displays sharp ridges and vertices along the wrinkles after crumpling process (FIGS. 19A and 19B), presumably emanating from the dissimilar Young's moduli of the two materials. Detailed mechanism using MD simulation is currently underway. Moreover, the 3D self-supporting MoS₂ crumples can be readily deposited in a scalable fashion onto flexible CFEs under analogous EHD conditions for CGNs as indicated in HRSEM images (FIGS. 18B and 18C). Corresponding EDX mapping further conclusively provides the spatial distribution of the pertinent element (C in red, Mo in green, and S in blue) as shown in FIG. 18D, to 18F, confirming the formation of 3D crumpled MoS₂ (CMoS₂) coatings. Of particular interest is the elimination of underlying scaffolds that could provide a new route to simultaneously increase the surface area and expose the catalytically active edges of MoS₂ sheets for hydrogen evolution reaction (HER). This new approach also allows the direct integration of chemically exfoliated MoS₂ which can be readily produced in gram scale for effective evolution of hydrogen.⁶³

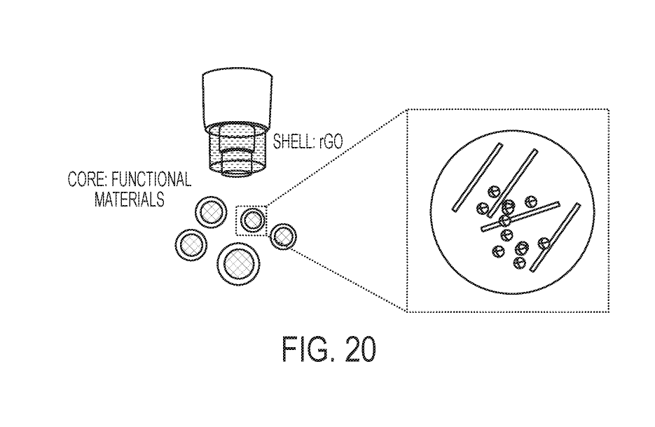

The utility of the EHD process is further demonstrated via the direct entrapment of inorganic nanoparticles within CGNs through the incorporation of coaxial needles as schematically illustrated in FIG. 20. As a first proof of concept, semiconducting TiO₂ and silicon (Si) nanoparticles (FIGS. 19C and 19E) were infiltrated within the available volume of CGNs as confirmed by HRSEM (FIGS. 19D and 19F) and EDX (FIGS. 18G and 18H). In particular, the infiltration of discrete TiO₂ nanoparticles was found to form a conformal contact with the exceedingly thin CGN membranes, presumably due to the electrostatic assembly at liquid/liquid interfaces where positively charged TiO₂ nanoparticles self-adhered onto the negatively charged surface of CGNs. This morphological feature not only reduces the diffusion length of carrier propagation but also relaxes the constraints of problematic phase-separation that often takes place in the aerosol approach. On the other hand, the self-adaptable, ion diffusible and chemically resilient nature of CGNs may find great use in responsive barriers to dynamically accommodate volumetric expansion during charge/discharge cycles of Si nanoparticle based lithium batteries.⁶⁴ As shown FIG. 19F, a cluster of Si nanoparticles arranged in a tetrahedral fashion is tightly wrapped by the CGNs. Noted that the numbers and arrangement of silicon nanoparticles can be further engineered through the control of droplet diameters and density-assisted emulsions.⁶⁵ Nevertheless, given the wide variety of functional nanoparticles, and the versatility and flexibility offered by EHD process, we anticipate that many structurally robust, electronically heterogeneous, and catalytically active, multifunctional hybrid CGN nanocomposites that are previously unattainable or require sophisticated molecular self-assembling strategies due to the incompatible solubility characteristics can be readily, rapidly and rationally assembled through this template free, scalable, and green nanomanufacturing route. This will in turn facilitate their implementation and exploration for numerous applications including energy harvesting, storage, catalysis, reactors and separation, drug delivery, biocompatible scaffolds, sensing and highly complexity composites.

Methods

Synthesis of CGN Monoliths from rGO Dispersions

rGO dispersions was synthesized based on the published method.²² In essence, GO colloids (0.5 mg/ml, 40 ml) made from the modified Hummers' approach was mixed with 0.1 ml hydrazine (35 wt % in water) and 0.56 ml ammonia (28 wt % in water) to adjust pH to 11 in a flask and stir in a oil bath at 95° C. for 1 hour. Flat rGO papers were prepared by vacuum filtrating of 8 ml as obtained rGO colloidal dispersion through an isopore membrane filter paper (100 nm pore size). To synthesize CGNs, rGO dispersions (50 μg/mL) were fed through a customized EHD setup (FIGS. 2A-2C). Note that pH of rGO dispersion must maintain at 11 to obtain necessary electrostatic force for isolating individual rGO sheets. In a typical experiment, solutions are fed to the spray head (gauge 23 TW needle) by a syringe pump. Electric fields are generated through a high power supply (ES 40P-20 W/DAM, Gamma high voltage research) with a distance of 10 cm measured from the tip of spinneret to collecting substrates. Computerized multi-pass deposition is achieved through the integration of x-y translational stage (Newport, moving speed 2 mm/sec) and micro-heating plate. A table of detailed operating parameters, including concentration, solution feed rate, and annealing temperature, to afford CGNs can be found in Table 1.

Characterization of CGNs

The morphologies of CGNs were examined by field emission SEM integrated with energy dispersive X-ray spectroscopy (EDX, ULTRA-55), atomic force microscopy (Multimode, DI) and optical microscopy (Leica DM-2500). Zeta potential was measured with Malvern Instruments' Zetasizer Nanosystem. The conductivity measurements of CGN networks were made by depositing CGNs for 40 hours on a pre-cleaned Si substrate with a thermally grown 300 nm SiO₂ and were analyzed with a field effect transistor configuration using a semiconductor analyzer (Keithley 2400). Electrical contact was made possible by thermally evaporating a combination of gold and chromium electrodes (100 nm) under vacuum of 5×10⁻⁸ torr. The channel length (200 μm) between two electrodes is defined by using a shadow mask. The surface area measurements were carried out at a liquid nitrogen temperature on a Tristar II series. The volume of the CGN films was calculated through multiplying the thickness by area (0.8 cm×0.8 cm). Thickness of CGN films was determined through cross sectional SEM images. As a control experiment, thickness of rGO films was calculated in a similar manner.

Electrochemical Measurements

The electrochemical characterization was conducted by applying constant current discharge/charge cycles and impedance measurements were done in a symmetrical coin-call configuration (MTI CR2016) using a similar procedure reported in the literature.^{3,46,47} Stainless steel current collectors were used to define device area and substrates for CGN deposition. The size of all electrode films were fixed to ˜0.8 cm×0.8 cm in accordance with the diameter of stainless steel collectors. Prior to deposition, a thin, corrugated rGO film created from room temperature EHD process (rGO concentration of 500 μg/mL, electric field of 0.575 kV/cm, pH at 11, and flow rate of 20 μL/min and deposition time of 5 hours) was used as a conductive scaffold to ensure the efficiency and density of subsequent CGN deposition. To rule out the effect of rGO and possible overestimation, the mass of rGO paper was subtracted from the mass loading of whole electrode stacks as well as calculation of capacitance. Aerial mass loading levels of 2 mg to 16 mg per electrode were achieved through iterative deposition from 10 to 80 hours, under the operating conditions of concentration of 50 μg/ml, flow rate of 4 μg/min and surrounding temperature of 255° C. rGO paper based electrodes of different loading mass were made by direct filtration of rGO dispersions of various concentrations. KOH solution (5M) was used as the electrolyte and a glassy fiber filter paper was used as the separator. It is noted that iterative pre-scans were performed with a scan rate of 50 mV/s to ensure the stabilization of the devices. The data presented were taken upon the superimposition of each current-voltage loops. The galvanostatic charge/discharge curves were conducted at different scan rates from 0.1 to 10 A/g while the electrochemical impedance spectroscopy measurements were performed under a sinusoidal signal over a frequency range from 10³ to 10⁻² Hz with a magnitude of 5 mV. Device performance and calculation were based on published reports. 10,46,47

Synthesis and Characterization of 3D CGN Scaffolds

In a typical preparation of 3D CGNs, CFEs were pretreated with UV/ozone for 15 min to remove any contamination. rGO dispersions in a mixture of isopropanol (IPA): deionized water (DI-H₂O) (v/v, 3: 7), pH at 11, applied electric field of 0.575 kV/cm and a concentration of 50 μg/mL, a flow rate of 4 μL/min were directly deposited on CFE. The total deposition time is seven and half minutes and the substrate is pre-annealed at 200° C. Finally, the deposition of TiO₂ particulate photoanode is prepared based on a published strategy.^{53,54} A 5 mg/mL suspension of TiO₂ (Anatase, 25 nm in diameter, Sigma Aldrich) in methanol was prepared and sonicated using a VWR table top sonicator for 30 minutes to ensure stable dispersion. A total volume of 650 μL TiO₂ colloidal suspensions was directly drop-casted. Pt wire and Ag/AgCl were used as counter and reference electrodes, respectively. To ensure electrical contact, the CFE/CGN/TiO₂ working electrode was connected through a toothless alligator clip, which was then connected to a tandem working station comprised of a CH Instruments and a photovoltaic characterization setup (QE-5 IPCE, ENLI Tech, Taiwan). 1.2 mM KOH solution was used as the electrolyte, which was made from dissolving 61.5 mg KOH (reagent grade, Sigma-Aldrich) into 900 mL DI water and 100 mL ethylene glycol (anhydrous, Sigma-Aldrich). Ethylene glycol was added to adjust the pH value to 8 as well as increase the electrolyte conductivity. The working electrode was illuminated by a 150 W simulated Xenon light source with an AM 1.5 global illumination filter to get an intensity of 100 mW/cm². Linear sweep voltammetry sequences were performed to identify the photocurrent density as well as the open circuit potential of the devices. In addition, photocurrent densities in response with light switch tests were measured through Bulk Electrolysis with Coulometry technique.

Coaxial EHD-Assembly of CGN Hybrid Nanocomposites

Chemically exfoliated MoS₂ sheets were prepared followed the protocol as reported.⁶⁶ TiO₂ (˜25 nm in diameter, Sigma Aldrich), and silicon (Si) nanoparticles (˜5 nm in diameter in American Elements) were used as received unless specified elsewhere. Clay nanosheets was received from Rockwood Ltd. (Lapointe XLG) In a typical procedure for synthesis of CMoS₂, solutions of MoS₂ (55 ug/mL, DI:IPA=7:3, pH=6) were directly sprayed at the conditions of 0.575 kV/cm, 4 uL/min, 7.5 min, and 200° C. As for CNS, the processing conditions were identical to the CMoS₂ except for concentration of 1 mg/mL. To constitute a stable dispersion, CNS first mixed with sodium polyacrylate. Upon mixing, the highly entangled clay nanosheets are exfoliated and dispersed homogenously owing to the mutual repulsion caused by site-specific wrapping of anionic sodium polyacrylate. Hybrid CGN composites were prepared separately in a mixture of IPA and DI-H₂O (v/v, 3:7). The concentrations of Si and TiO₂ nanoparticles are 200 μg/mL. Two phases were injected through the customized coaxial spinneret (100-10-COAXIAL, Ramé-hart Instrument Co.) under a feed rate of 4 μl/min, spraying time of 10 minutes, electric field Of 0.575 KV/cm, and surrounding temperature of 255° C. It is noted that coaxial EHD spinneret was used as rGO dispersion was fed through the shell. CGN/TiO₂ and CGN/Si composites were synthesized in an analogous manner.

### REFERENCES

1 Rogers, J. A., Lagally, M. G. & Nuzzo, R. G. Synthesis, assembly and applications of semiconductor nanomembranes. Nature 477, 45-53, doi:Doi 10.1038/Nature10381 (2011).
2 Luo, J. Y. et al. Compression and Aggregation-Resistant Particles of Crumpled Soft Sheets. Acs Nano 5, 8943-8949, doi:Doi 10.1021/Nn203115u (2011).
3 Luo, J. Y., Jang, H. D. & Huang, J. X. Effect of Sheet Morphology on the Scalability of Graphene-Based Ultracapacitors. Acs Nano 7, 1464-1471, doi:Doi 10.1021/Nn3052378 (2013).
4 Cranford, S. W. & Buehler, M. J. Packing efficiency and accessible surface area of crumpled graphene. Phys Rev B 84, doi:Artn 205451Doi 10.1103/Physrevb.84.205451 (2011).
5 Chen, Y. T. et al. Aerosol Synthesis of Cargo-Filled Graphene Nanosacks. Nano Lett 12, 1996-2002, doi:Doi 10.1021/N12045952 (2012).
6 Lee, J. S., Kim, S. I., Yoon, J. C. & Jang, J. H. Chemical Vapor Deposition of Mesoporous Graphene Nanoballs for Supercapacitor. ACS Nano 7, 6047-6055, doi:Doi 10.1021/Nn401850z (2013).
7 Zang, J. F. et al. Multifunctionality and control of the crumpling and unfolding of large-area graphene. Nat Mater 12, 321-325, doi:Doi 10.1038/Nmat3542 (2013).
8 Xiao, L. et al. Crumpled graphene particles for microbial fuel cell electrodes. J Power Sources 208, 187-192, doi:Doi 10.1016/J.Jpowsour.2012.02.036 (2012).
9 Kim, K. S. et al. Large-scale pattern growth of graphene films for stretchable transparent electrodes. Nature 457, 706-710, doi:Doi 10.1038/Nature07719 (2009).
10 Wang, X. B. et al. Three-dimensional strutted graphene grown by substrate-free sugar blowing for high-power-density supercapacitors. Nat Commun 4, doi:Artn 2905Doi 10.1038/Ncomms3905 (2013).
11 Chen, Z. P. et al. Three-dimensional flexible and conductive interconnected graphene networks grown by chemical vapour deposition. Nat Mater 10, 424-428, doi:Doi 10.1038/Nmat3001 (2011).
12 Yoon, J. C., Lee, J. S., Kim, S. I., Kim, K. H. & Jang, J. H. Three-Dimensional Graphene Nano-Networks with High Quality and Mass Production Capability via Precursor-Assisted Chemical Vapor Deposition. Scientific Reports 3, doi:Artn 1788 Doi 10.1038/Srep01788 (2013).
13 Choi, B. G., Yang, M., Hong, W. H., Choi, J. W. & Huh, Y. S. 3D Macroporous Graphene Frameworks for Supercapacitors with High Energy and Power Densities. Acs Nano 6, 4020-4028, doi:Doi 10.1021/Nn3003345 (2012).
14 Ma, X. F., Zachariah, M. R. & Zangmeister, C. D. Crumpled Nanopaper from Graphene Oxide. Nano Lett 12, 486-489, doi:Doi 10.1021/N1203964z (2012).
15 Subramoney, S. Novel nanocarbons—Structure, properties, and potential applications. Adv Mater 10, 1157-+, doi:Doi 10.1002/(Sici)1521-4095(199810)10:15<1157::Aid-Adma1157>3.0.Co; 2-N(1998).
16 Caiulo, N. et al. Carbon-decorated FePt nanoparticles. Adv Funct Mater 17, 1392-1396, doi:Doi 10.1002/Adfm.200601200 (2007).
17 Wang, L. B. et al. One-pot synthesis of carbon-decorated FePt nanoparticles and their application for label-free electrochemical impedance sensing of DNA hybridization. Rsc Adv 3, 9042-9046, doi:Doi 10.1039/C3ra23303k (2013).
18 Chhowalla, M. et al. The chemistry of two-dimensional layered transition metal dichalcogenide nanosheets. Nat Chem 5, 263-275, doi:Doi 10.1038/Nchem.1589 (2013).
19 Ji, H. X. et al. Capacitance of carbon-based electrical double-layer capacitors. Nat Commun 5, doi:Artn 3317 Doi 10.1038/Ncomms4317 (2014).
20 Wen, X. et al. Crumpled and Collapsed Conformations in Graphite Oxide Membranes. Nature 355, 426-428, doi:Doi 10.1038/355426a0 (1992).
21 Bets, K. V. & Yakobson, B. I. Spontaneous Twist and Intrinsic Instabilities of Pristine Graphene Nanoribbons. Nano Res 2, 161-166, doi:Doi 10.1007/S12274-009-9015-X (2009).
22 Li, D., Muller, M. B., Gilje, S., Kaner, R. B. & Wallace, G. G. Processable aqueous dispersions of graphene nanosheets. Nature Nanotech. 3, 101-105, doi:Doi 10.1038/Nnano 0.2007.451 (2008).
23 Cote, L. J., Kim, F. & Huang, J. X. Langmuir-Blodgett Assembly of Graphite Oxide Single Layers. J Am Chem Soc 131, 1043-1049, doi:Doi 10.1021/Ja806262m (2009).
24 Kim, J. et al. Graphene Oxide Sheets at Interfaces. J. Am. Chem. Soc. 132, 8180-8186, doi:Doi 10.1021/Ja102777p (2010).
25 Isbom Christine, T. C., Ashlie Martini, Erin Johnson, Otero-de-la-Roza Alberto, Vincet C Tung. Carbon Nanotube Chirality Determines Efficiency of Electron Transfer to Fullerene in All-Carbon Photovoltaics. Journal of physical chemistry letters 4, 2914-2917 (2013).
26 Tang Chun, 0. T., Tung C. Vincent, Martini Ashlie. Structure-Stability Relationships for Graphene-Wrapped Fullerene-Coated Carbon Nanotubes. Carbon 61, 458-463 (2013).
27 Kim, P., Abkarian, M. & Stone, H. A. Hierarchical folding of elastic membranes under biaxial compressive stress. Nat Mater 10, 952-957, doi:Doi 10.1038/Nmat3144 (2011).
28 Patra, N., Song, Y. B. & Kral, P. Self-Assembly of Graphene Nanostructures on Nanotubes. Acs Nano 5, 1798-1804, doi:Doi 10.1021/Nn102531h (2011).
29 Patra, N., Wang, B. Y. & Kral, P. Nanodroplet Activated and Guided Folding of Graphene Nanostructures. Nano Lett 9, 3766-3771, doi:Doi 10.1021/N19019616 (2009).
30 Bao, W. Z. et al. Controlled ripple texturing of suspended graphene and ultrathin graphite membranes. Nat Nanotechnol 4, 562-566, doi:Doi 10.1038/Nnano.2009.191 (2009).
31 Lee, C., Wei, X. D., Kysar, J. W. & Hone, J. Measurement of the elastic properties and intrinsic strength of monolayer graphene. Science 321, 385-388, doi:Doi 10.1126/Science.1157996 (2008).
32 Warner, J. H. et al. Dislocation-Driven Deformations in Graphene. Science 337, 209-212, doi:Doi 10.1126/Science.1217529 (2012).
33 Li, D., Marquez, M. & Xia, Y. N. Capturing electrified nanodroplets under Rayleigh instability by coupling electrospray with a sol-gel reaction. Chem Phys Lett 445, 271-275, doi:Doi 10.1016/J.Cplett.2007.07.090 (2007).
34 Jaworek, A. & Sobczyk, A. T. Electrospraying route to nanotechnology: An overview. J Electrostat 66, 197-219, doi:Doi 10.1016/J.Elstat.2007.10.001 (2008).
35 Li, D., Wang, Y. L. & Xia, Y. N. Electrospinning of polymeric and ceramic nanofibers as uniaxially aligned arrays. Nano Lett 3, 1167-1171, doi:Doi 10.1021/N10344256 (2003).
36 Gaskell, S. Electrospray: Principles and practice (vol 32, pg 677, 1997). J Mass Spectrom 32, 1378-1378, doi:Doi 10.1002/(Sici)1096-9888(199712)32:12<1378::Aid-Jms1600>3.0.Co; 2-P (1997).
37 Wang, S. R., Zhang, Y., Abidi, N. & Cabrales, L. Wettability and Surface Free Energy of Graphene Films. Langmuir 25, 11078-11081, doi:Doi 10.1021/La901402f (2009).
37 Carpi, F., Frediani, G., Turco, S. & De Rossi, D. Bioinspired Tunable Lens with Muscle-Like Electroactive Elastomers. Adv Funct Mater 21, 4152-4158, doi:Doi 10.1002/Adfm.201101253 (2011).
39 Stohr, R. J. et al. Super-resolution Fluorescence Quenching Microscopy of Graphene. Acs Nano 6, 9175-9181, doi:Doi 10.1021/Nn303510p (2012).
40 Kim, J., Cote, L. J., Kim, F. & Huang, J. X. Visualizing Graphene Based Sheets by Fluorescence Quenching Microscopy. J Am Chem Soc 132, 260-267, doi:Doi 10.1021/Ja906730d (2010).
41 Stankovich, S. et al. Synthesis of graphene-based nanosheets via chemical reduction of exfoliated graphite oxide. Carbon 45, 1558-1565, doi:Doi 10.1016/J.Carbon.2007.02.034 (2007).
42 Fasolino, A., Los, J. H. & Katsnelson, M. I. Intrinsic ripples in graphene. Nat Mater 6, 858-861, doi:Doi 10.1038/Nmat2011 (2007).
43 Shao, J. J., Lv, W. & Yang, Q. H. Self-Assembly of Graphene Oxide at Interfaces. Adv Mater 26, 5586-5612, doi:Doi 10.1002/Adma.201400267 (2014).
44 Everett, D. H. Basic Principles of Colloid Science (The Royan Society of Chemistry, 1988).
45 Cloupeau, M. & Prunetfoch, B. Electrohydrodynamic Spraying Functioning Modes—a Critical-Review. J Aerosol Sci 25, 1021-1036, doi:Doi 10.1016/0021-8502(94)90199-6 (1994).
46 El-Kady, M. F., Strong, V., Dubin, S. & Kaner, R. B. Laser Scribing of High-Performance and Flexible Graphene-Based Electrochemical Capacitors. Science 335, 1326-1330, doi:Doi 10.1126/Science.1216744 (2012).
47 Yang, X. W., Cheng, C., Wang, Y. F., Qiu, L. & Li, D. Liquid-Mediated Dense Integration of Graphene Materials for Compact Capacitive Energy Storage. Science 341, 534-537, doi:Doi 10.1126/Science.1239089 (2013).
48 Frackowiak, E. & Beguin, F. Carbon materials for the electrochemical storage of energy in capacitors. Carbon 39, 937-950, doi:Doi 10.1016/S0008-6223(00)00183-4 (2001).
49 Bird, J. C., Dhiman, R., Kwon, H. M. & Varanasi, K. K. Reducing the contact time of a bouncing drop (vol 503, pg 385, 2013). Nature 505, doi:Doi 10.1038/Nature12895 (2014).
50 Han, X. G. et al. Scalable Holey Graphene Synthesis and Dense Electrode Fabrication toward High-Performance Ultracapacitors. Acs Nano 8, 8255-8265, doi:Doi 10.1021/Nn502635y (2014).
51 Xu, Y. X. et al. Holey graphene frameworks for highly efficient capacitive energy storage. Nat Commun 5, doi:Artn 4554 Doi 10.1038/Ncomms5554 (2014).
52 Kim, M., Safron, N. S., Han, E., Arnold, M. S. & Gopalan, P. Fabrication and Characterization of Large-Area, Semiconducting Nanoperforated Graphene Materials. Nano Lett 10, 1125-1131, doi:Doi 10.1021/N19032318 (2010).
53 Ng, Y. H., Lightcap, I. V., Goodwin, K., Matsumura, M. & Kamat, P. V. To What Extent Do Graphene Scaffolds Improve the Photovoltaic and Photocatalytic Response of TiO₂ Nanostructured Films? Journal of Physical Chemistry Letters 1, 2222-2227, doi:Doi 10.1021/Jz100728z (2010).
54 Radich, J. G., Krenselewski, A. L., Zhu, J. D. & Kamat, P. V. Is Graphene a Stable Platform for Photocatalysis? Mineralization of Reduced Graphene Oxide With UV-Irradiated TiO₂ Nanoparticles. Chem Mater 26, 4662-4668, doi:Doi 10.1021/Cm5026552 (2014).
55 Pint, C. L. et al. Rationally Designed, Three-Dimensional Carbon Nanotube Back-Contacts for Efficient Solar Devices. Adv Energy Mater 1, 1040-1045, doi:Doi 10.1002/Aenm.201100436 (2011).
56 Hwang, Y. J., Boukai, A. & Yang, P. D. High Density n-Si/n-TiO2 Core/Shell Nanowire Arrays with Enhanced Photoactivity. Nano Lett 9, 410-415, doi:Doi 10.1021/N18032763 (2009).
57 Eda, G. & Chhowalla, M. Chemically Derived Graphene Oxide: Towards Large-Area Thin-Film Electronics and Optoelectronics. Adv Mater 22, 2392-2415, doi:Doi 10.1002/Adma.200903689 (2010).
58 Park, J. H., Kim, S. & Bard, A. J. Novel carbon-doped TiO₂ nanotube arrays with high aspect ratios for efficient solar water splitting. Nano Lett 6, 24-28, doi:Doi 10.1021/N1051807y (2006).
59 Docampo, P., Ball, J. M., Darwich, M., Eperon, G. E. & Snaith, H. J. Efficient organometal trihalide perovskite planar-heterojunction solar cells on flexible polymer substrates. Nat Commun 4, doi:Artn 2761 Doi 10.1038/Ncomms3761 (2013).
60 You, J. B. et al. Low-Temperature Solution-Processed Perovskite Solar Cells with High Efficiency and Flexibility. Acs Nano 8, 1674-1680, doi:Doi 10.1021/Nn406020d (2014).
61 Zhou, H. P. et al. Interface engineering of highly efficient perovskite solar cells. Science 345, 542-546, doi:Doi 10.1126/Science.1254050 (2014).
62 Qiu, L., Liu, J. Z., Chang, S. L. Y., Wu, Y. Z. & Li, D. Biomimetic superelastic graphene-based cellular monoliths. Nat Commun 3, doi:Artn 1241 Doi 10.1038/Ncomms2251 (2012).
63 Kibsgaard, J., Chen, Z. B., Reinecke, B. N. & Jaramillo, T. F. Engineering the surface structure of MoS2 to preferentially expose active edge sites for electrocatalysis. Nat Mater 11, 963-969, doi:Doi 10.1038/Nmat3439 (2012).
64 Liu, N. et al. A pomegranate-inspired nanoscale design for large-volume-change lithium battery anodes. Nat Nanotechnol 9, 187-192, doi:Doi 10.1038/Nnano.2014.6 (2014).
65 Cho, Y. S., Yi, G. R., Kim, S. H., Pine, D. J. & Yang, S. M. Colloidal clusters of microspheres from water-in-oil emulsions. Chem Mater 17, 5006-5013, doi:Doi 10.1021/Cm051123r (2005).
66 Chou, S. S. et al. Ligand Conjugation of Chemically Exfoliated MoS2. J Am Chem Soc 135, 4584-4587, doi:Doi 10.1021/Ja310929s (2013).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method for producing a nanostructure or an article having at least a nanostructured portion, comprising:
obtaining a colloidal suspension of sheets of material for forming nanoparticles, said sheets being less than four atomic layers thick and said colloidal suspension having a preselected concentration of said sheets of material suspended therein;
supplying said colloidal suspension to an electro-hydrodynamic system, said electro-hydrodynamic system comprising:
a spray nozzle,
a ground electrode spaced apart from said spray nozzle,
and a high voltage DC power supply electrically connected to said spray nozzle and said ground electrode, said high voltage DC Power supply being suitable for supplying at least a 0.05 kV/cm electric field between said spray nozzle and said ground electrode;
providing a substrate arranged between said spray nozzle and said ground electrode such that droplets from said spray nozzle are directed to said substrate to deposit nanostructures thereon; and
applying a DC voltage using said high voltage DC power supply between said spray nozzle and said ground electrode such that charged droplets from said spray nozzle are repelled from said spray nozzle and attracted towards said substrate,
wherein said DC voltage is selected such that said droplets have sizes sufficiently small to result in substantially isolated sheets within each droplet.

2. The method of claim 1, wherein said applying said DC voltage applies a voltage to provide at least a 0.1 kV/cm electric field between said spray nozzle and said ground electrode.

3. The method of claim 1, wherein said applying said DC voltage applies a voltage to provide at least a 0.575 kV/cm electric field between said spray nozzle and said ground electrode.

4. The method of claim 1, wherein said substrate comprises a hydrophilic surface portion such that said sheets in said droplets remain substantially flat nanostructures upon being deposited.

5. The method of claim 1, wherein said substrate comprises a hydrophobic surface portion such that said sheets in said droplets become crumpled nanostructures upon being deposited.

6. The method of claim 1, further comprising heating said substrate.

7. The method of claim 6, wherein said heating said substrate is performed at least partially during deposition such that droplets from said spray nozzle at least partially evaporate liquid portions of said droplets prior to being deposited on said substrate.

8. The method of claim 7, wherein said heating said substrate is also performed subsequent to said droplets being deposited on said substrate as an annealing process.

9. The method of claim 6, wherein said heating said substrate is performed subsequent to said droplets being deposited on said substrate as an annealing process.

10. The method of claim 1, wherein said sheets of material for forming nanoparticles are graphene sheets.

11. The method of claim 1, wherein said sheets of material for forming nanoparticles are monolayer graphene sheets having single atomic layer thicknesses.

12. The method of claim 10, wherein said droplet solution has a pH selected to provide said nanoparticles with a predetermined minimum zeta potential magnitude such that said droplets sprayed from said spray nozzle are charged to be accelerated away from said spray nozzle and towards said substrate.

13. The method of claim 12, wherein said droplet solution has a pH greater than 7.

14. The method of claim 12, wherein said droplet solution has a pH of about 11.

15. The method of claim 11, wherein said droplet solution has a pH selected to provide said nanoparticles with a predetermined minimum zeta potential magnitude such that said droplets sprayed from said spray nozzle are charged to be accelerated away from said spray nozzle and towards said substrate.

16. The method of claim 1, wherein said sheets of material for forming nanoparticles are at least one of graphene, clay, semiconductor, metal, metal chalcogenide, dichacolgenide or transitional metal dichalcogenide sheets.

17. The method of claim 1, further comprising moving said substrate to deposit said nanoparticles over a selected surface area.

18. The method of claim 1, wherein a volatility of said colloidal suspension is predetermined such that said droplets substantially evaporate over said distance between said spray nozzle and said substrate such that modified nanoparticles are deposited on said substrate.

19. The method of claim 1, further comprising obtaining a second colloidal suspension of sheets of material for forming said nanoparticles, said sheets being less than four atomic layers thick and said colloidal suspension having a preselected concentration of said sheets of material suspended therein;
supplying said second colloidal suspension to an inner nozzle portion of said spray nozzle of electro-hydrodynamic system to produce composite droplets and composite nanostructures deposited on said substrate.

20. A nanostructured article or nanostructured article portion produced using the method of claim 1.

21. An article of manufacture comprising a nanostructured article portion produced using the method of claim 1.

22. The article of manufacture of claim 21, wherein the nanostructured article portion is at least one of a component of or a layer of an electronic device.

23. A nanostructure or an article having at least a nanostructured portion comprising a plurality of crumpled nanoparticles formed into a self-supporting structure, wherein said crumpled nanoparticles comprise walls having thicknesses of less than four atomic layers.

24. The nanostructure or an article having at least a nanostructured portion according to claim 23, wherein said crumpled nanoparticles comprise walls having thicknesses of one atomic layer.

25. The nanostructure or an article having at least a nanostructured portion according to claim 23, wherein said crumpled nanoparticles are crumpled graphene nanoparticles and nanostructure or an article having at least a nanostructured portion is a filter.

26. The nanostructure or an article having at least a nanostructured portion according to claim 25, wherein said filter has a porosity suitable for water desalination.
